(19) United States
(12) Patent Application Publication
(10) Pub. No.: US 2023/0301370 A1
(43) Pub. Date: Sep. 28, 2023

(54) FLAT KNITTED OR ENGINEERED KNIT UPPER TORSO MULTI-LAYERED PRODUCT

(71) Applicant: MAS Fabrics (Private) Limited, Colombo 02 (LK)

(72) Inventors: Sampath Gunasekara, Colombo 02 (LK); Roshan Munagamage, Colombo 02 (LK)

(21) Appl. No.: 18/020,849

(22) PCT Filed: Aug. 13, 2021
(86) PCT No.: PCT/SG2021/050473

§ 371 Date: Feb. 10, 2023

(30) Foreign Application Priority Data
Aug. 14, 2020 (SG) 10202007812R
Nov. 4, 2020 (SG) 10202010980V
Mar. 8, 2021 (SG) 10202102328X

(51) Int. Cl. A41C 3/00

(52) U.S. Cl. CPC A41C 3/0014

(57) ABSTRACT

Disclosed herein is a double-knit flat-knit textile element, that may be used to form an upper torso garment, such as a bra. The double-knit flat-knit textile element requires a first zone comprising an anchoring band and a second zone having a first bra cup region and a second bra cup region formed from at least two layers, where the second zone is joined to the first zone by a seamless transition. The bra cup regions formed from at least two layers require a first layer formed as a single or a double jersey fabric and a second layer formed as a single or a double jersey fabric.

### FIELD OF INVENTION

The current invention relates to a flat knitted or engineered upper torso multi-layered product, such as a bra.

### BACKGROUND

The listing or discussion of a prior-published document in this specification should not necessarily be taken as an acknowledgement that the document is part of the state of the art or is common general knowledge.

Contemporary upper torso garments, such as bras, may suffer from poor fit and comfort and it is difficult to provide a garment that can be adapted to fit the body of a wearer without making it overly complex and expensive to manufacture.

### SUMMARY OF INVENTION

It has been surprisingly found that it is possible to provide an upper torso garment as a fully knitted garment (e.g. a bra) in one knit to shape panel that includes engineered cups with an integrated cookie pocket and inbuilt zonal structures that can provide the garment with a four-way stretch fabric that provides fit flexibility to the wearer. In addition, the garment can adapt to body changes. For example, if formed as a bra, the garment can adapt to cup size variation of the wearer (e.g. due to the cookie pocket) or to different body shapes amongst wearers of the same size of bra. Additionally, the construction of the garment may be conducted with minimal trims and operations, making the garment cost effective to manufacture, with minimal wastage, making it environmentally friendly.

Aspects and embodiments of the invention are provided in the following numbered clauses.

1. A double-knit flat-knit textile element, comprising:
a first zone comprising an anchoring band; and
a second zone comprising a first bra cup region and a second bra cup region formed from at least two layers, where the second zone is joined to the first zone by a seamless transition, wherein the first and the second bra cup regions formed from at least two layers
a first layer formed as a single or a double jersey fabric; and
a second layer formed as a single or a double jersey fabric, optionally wherein the first layer is formed as a double jersey fabric; and the second layer is formed as a single jersey fabric.

2. The double-knit flat-knit textile element according to Clause 1, wherein the first and second bra cup regions formed from at least two layers further comprise a third layer formed between the first and second layers, the third layer formed from one or more of the group consisting of a single jersey fabric, a double jersey fabric, an engineered fabric and a single jersey mesh fabric, optionally wherein the third layer is formed as a single jersey mesh fabric or as an engineered fabric.

3. The double-knit flat-knit textile element according to Clause 1 or Clause 2, wherein:
(a) the first and second bra cup regions formed from at least two layers have an unutilised volume; and/or
(b) the textile element does not include a three-dimensional knit structure; and/or
(c) the first and second bra cup regions formed from at least two layers have an unutilised volume and the textile element is constructed so as to provide support to the first and second bra cup regions and use said unutilised volume to create a three dimensional shape when contoured against a wearer's body; and/or
(d) the textile element is constructed to provide sufficient support to the first and the second bra cup region, which uses the unutilised volume created through knit to create the three dimensional shape by contouring against a wearer's body.

4. The double-knit flat-knit textile element according to Clause 3, wherein the first and second bra cup regions formed from at least two layers house a bra cup cookie that provides the first and second cup regions with a three dimensional shape configured to complement the shape of a wearer by occupying at least part of the unutilised volume of the first and second bra cup regions formed from at least two layers.

5. The double-knit flat-knit textile element according to any one of the preceding clauses, wherein the first and second bra cup regions formed from at least two layers further comprise a seamlessly integrated aperture suitable for the insertion of a bra cup cookie.

6. The double-knit flat-knit textile element according to any one of the preceding clauses, wherein the second zone further comprises a first and second apex region around at least part of a periphery of the first and second cup regions formed from at least two layers, respectively, where each apex region is formed from a single fabric layer that is formed through a seamless transition from the at least two layers in the first and second bra cup regions, optionally wherein, the periphery of the first and second knit bra cup regions formed from at least two layers seamlessly transitions from at least two layers of fabric to a single layer double jersey knit.

7. The double-knit flat-knit textile element according to any one of the preceding clauses, wherein the second zone further comprises a central portion that connects the first and second bra cup regions, where the central portion is seamlessly joined to the first and second bra cup regions, optionally wherein:
(a) the central portion has a different stitch sequence or stitch pattern to any of the sequences/patterns in the bra cup region and the anchoring band; and/or
(b) the central portion has a different knit loop length, which gives said area a different stretch and recovery property and/or modulus, compared to the bra cup region and the anchoring band.

8. The double-knit flat-knit textile element according to Clause 7, wherein the central portion of the second zone:
(a) is created as a single layer double jersey fabric by transitioning from at least two layers of fabric; and/or
(b) separates the first and the second bra cup region to provide encapsulation while limiting in and out movement of the breasts; and/or
(c) provides additional support to the anchoring band.

9. The double-knit flat-knit textile element according to any one of the preceding clauses, wherein the second zone further comprises:
strap portions, optionally wherein each strap portion is formed by knitting a first strap layer and a second strap layer, where both strap layers are formed by a double jersey spacer structure and are connected together by one or more tuck stitches, optionally wherein:
(i) the first and second strap layers use different stitch sequences to provide a strap that has a cushioning effect, optionally wherein the first and second strap layers have a different modulus level at any given point, which can be predefined in the knitting sequence; and/or
(ii) the double jersey structures of the first and second strap layers are not inlayed.

10. The double-knit flat-knit textile element according to Clauses 7 to 8 and Clause 9, as dependent upon Clauses 7 and 8, wherein the central portion further comprises an extension region that surrounds at least the first and second bra cup regions and the apex portion.

11. The double-knit flat-knit textile element according to Clauses 7 to 8 and Clauses 9 and 10, a loop length used in the central portion is shorter than a loop length of adjacent regions and/or portions in the second zone, such that the central portion is more rigid than the adjacent regions and/or portions.

12. The double-knit flat-knit textile element according to Clause 11, wherein the extension region has the same loop length as the central portion.

13. The double-knit flat-knit textile element according to any one of the preceding clauses, wherein the anchoring band is formed from a front knit, a back knit and a tuck stitch, optionally wherein the anchoring band is formed from a plurality of courses where the tuck stitch changes direction after each course.

14. The double-knit flat-knit textile element according to Clause 13, wherein the anchoring band has a different knit and/or stitch sequence compared to the rest of the textile element.

15. The double-knit flat-knit textile element according to any one of the preceding clauses, wherein the anchoring band has a first and second knit modulus zone, where a loop length of the first zone is different from the second zone.

16. The double-knit flat-knit textile element according to any one of the preceding clauses, wherein the second zone further comprises wing portions, optionally wherein the wing portion is knitted using a double jersey fabric structure to suit a desired fabric property.

17. The double-knit flat-knit textile element according to Clause 16 as dependent upon Clause 15, wherein:
the first knit modulus zone is positioned below the first and second cup regions; and
the second knit modulus zone is positioned below the wing portions, where the first knit modulus zone has a shorter knit loop length than the second knit modulus zone.

18. The double-knit flat-knit textile element according to any one of Clauses 7 to 8 and Clauses 9 to 17 as dependent upon any one of Clauses 7 to 8, wherein the central portion of the second zone is divided into a first section and a second section, where the first and second sections are adapted to be reversibly engageable with one another.

19. The double-knit flat-knit textile element according to Clause 17 or Clause 18, wherein:
the first section of the central portion is formed as a lateral extension of the first bra cup region; and
the second section of the central portion is formed as a lateral extension of the second bra cup region.

20. The double-knit flat-knit textile element according to Clause 19, wherein:
(a) each of the first and second bra cup regions terminate in a single unitary layer to form the lateral extension of the first and second sections, respectively, of the central portion are formed; and/or
(b) the first and second sections are independently formed as a single jersey knit and/or a double jersey knit.

21. The double-knit flat-knit textile element according to any one of Clauses 7 to 20, wherein the first and second sections of the central portion each comprise a lip-like aperture having an upper and lower portion, said lip-like aperture suitable for engagement with a means or apparatus to reversibly engage the first and second sections, optionally wherein by means or apparatus to reversibly engage the first and second sections maybe a zipper or hook and eye.

22. The double-knit flat-knit textile element according to Clause 21, wherein:
(a) the loop length of the upper lip portion is different to the loop length of an adjacent portion of the cup region and from the loop length of the bottom lip portion;
(b) the loop length of the bottom lip portion is different to the loop length of an adjacent portion of the cup region and from the loop length of the upper lip portion;
(c) the bottom lip portion is formed using a single jersey knit or a double jersey knit;
(d) the upper and bottom lip portions are formed to have a clean finished edge that requires no seaming operations; and the upper area of the lip like aperture has a bind-off which enables it to have a clean finished edge;
(e) the lip-like apertures house a zipper.

23. The double-knit flat-knit textile element according to any one of the preceding clauses, wherein the second zone further comprises a plurality of further regions comprising:
(a) a first and a second wing portion region;
(b) a neckline region;
(c) a cup connecting region;
(d) a first and a second cup periphery region corresponding to the first and second bra cup regions, respectively; and
(e) a first and second strap portion.

24. The double-knit flat-knit textile element according to Clause 23, wherein when the first and second bra cup regions formed from at least two layers further comprise a seamlessly integrated aperture suitable for the insertion of a bra cup cookie:
(a) the aperture is placed at a periphery of the first bra cup region and the second bra cup region such that it is placed either at a bottom portion of the first and/or bra cup region so as to be adjacent to the anchoring band or at a side of the first and/or second bra cup region so as to be adjacent to the bra cup surrounding area; and/or
(b) the aperture suitable for the insertion of a bra cup cookie is placed between the first and second layers and/or, when present, the second and third layers of the first bra cup and the second bra cup regions.

25. The double-knit flat-knit textile element according to Clause 23 or Clause 24, wherein the first and the second cup periphery region is a single layer that is created by a transition from a periphery of the first and second bra cup regions, having at least two layers, to the single layer of the first and the second cup periphery region, respectively.

26. The double-knit flat-knit textile element according to Clause 25, wherein the knit sequence of the first and the second cup periphery region is selected from one or more of the following:
(a) as per FIG. 33 a stitch sequence having a knit 1st row (61) with a front stitch rear tuck, front stitch, front stitch, front stitch, front stitch rear tuck, front stitch, front stitch; and a second row (62) in front stitch, front stitch, front stitch rear tuck, front stitch, front stitch, front stitch, front stitch rear tuck; a third row (63) of miss stitch, miss stitch, rear stitch, miss stitch, miss stitch, miss stitch, rear stitch; and a fourth row (64) of rear stitch, miss stich, miss stitch, miss stitch, rear stitch, miss stitch, miss stitch;
(b) as per FIG. 36 a stitch sequence having a 1st row (73) of front stitch, second row (74) of front tuck rear stitch, rear stitch, front tuck rear stitch, rear stitch, a third row (75) of front stitch, finally a fourth row (76) of rear stitch, front tuck rear stitch, rear stitch, front tuck rear stitch can also be used to knit this double jersey knit structure;
(e) the knit sequence of FIG. 31;
(f) the knit sequence of FIG. 32;
(g) the knit sequence of FIG. 34; and
(h) the knit sequence of FIG. 35.

27. The double-knit flat-knit textile element according to Clause 25 or Clause 26, wherein the first and the second cup periphery region is formed using one or more types of yarn selected from an elastic covered yarn and/or an uncovered version of the same yarn type.

28. The double-knit flat-knit textile element according to any one of Clauses 23 to 27, wherein the first and second strap portions are each formed by knitting a first strap layer and a second strap layer, where both strap layers are formed by a double jersey structure and are connected together by one or more tuck stitches, optionally wherein:
(i) the first and second strap layers use the same or different stitch sequences, are knitted: using covered or uncovered yarn; and by varying the tuck stitch sequence and the density to provide a cushion to provide a strap that has a cushioning effect; and/or
(ii) the first and second strap zones layers have a different modulus level at any given point, which is predefined by the knitting sequence to create a different zone compared to the rest of the flat-knit bra; and/or
(iii) the double jersey structures of the first and second strap layers are not inlayed.
(iv) each strap portion is divided into two distinct modulus sections defined by the mid-section and the boundary, where these two modulus sections of the strap zone are obtained by changing one or more of the stitch sequence, the loop length, and the type of yarn (e.g. covered or uncovered) in order to provide the two different sections.

29. The double-knit flat-knit textile element according to Clause 28, wherein one or more of the following apply:
(i) the stitch sequence of FIG. 44 forms the middle portion of the bottom half and top half of a flat knit bra strap area, and is formed from a first row (98) rear tuck, front tuck (99, RHS) second row; front stitch, rear stitch; and a third row (100) in front tuck, rear tuck; and finally, a fourth row (101) of rear stitch, front stitch, where a plurality of these repeated courses in a given area of repeat knit will combine to create a double jersey spacer knit structure, optionally wherein the stich sequence is knitted using covered and/or uncovered yarn;
(ii) FIG. 45 forms the middle portion of the bottom half and top half of a flat knit bra strap area, and is formed from a 1st row 102, second row 103, third row 104, optionally wherein the stich sequence is knitted using covered and/or uncovered yarn;
(iii) FIG. 46 forms the middle portion of the bottom half and top half of a flat knit bra strap area, and is formed from a first row 105, second row 106, third row 107, optionally wherein the stich sequence is knitted using covered and/or uncovered yarn;
(iv) FIG. 47 forms the middle portion and/or an edge or boundary of the bottom half and top half of a flat knit bra strap area, and is formed from a first row of (108) miss stitch, rear tuck, front tuck, miss stitch; second row of (109) miss stitch, rear stitch, miss stitch, rear stitch; third row (110) as front tuck, miss stitch, miss stitch, rear tuck; fourth row (111) of front stitch, miss stitch, front stitch, miss stitch, optionally wherein the stich sequence is knitted using covered and/or uncovered yarn;
(v) FIG. 48 forms the middle portion of the bottom half and top half of a flat knit bra strap area, and is formed from a first row 112, second row 113, third row 114, fourth row 115 which will create a double jersey spacer knit structure for the flat knit bra strap, optionally wherein the stich sequence is knitted using covered and/or uncovered yarn;
(vi) FIG. 49 forms the middle portion of the bottom half and top half of a flat knit bra strap area, and is formed from a first row 116, second row 117, third row 118, fourth row 119 which will create a double jersey spacer knit structure for the flat knit bra strap, optionally wherein the stich sequence is knitted using covered and/or uncovered yarn;
(vii) FIG. 50 forms the middle portion and/or an edge or boundary of the bottom half and top half of a flat knit bra strap area, and is formed from a first row 120, second row 121 which will create a double jersey spacer knit structure for the flat knit bra strap, optionally wherein the stich sequence is knitted using covered and/or uncovered yarn;
(viii) FIG. 51 forms the middle portion of the bottom half and top half of a flat knit bra strap area, and is formed from a first row 122, second row 123, third row 124, fourth row 125 which will create a double jersey spacer knit structure for the flat knit bra strap, optionally wherein the stich sequence is knitted using covered and/or uncovered yarn;
(ix) FIG. 52 forms the middle portion of the bottom half and top half of a flat knit bra strap area, and is formed from a first row 126, second row 127 which will create a double jersey spacer knit structure for the flat knit bra strap, optionally wherein the stich sequence is knitted using covered and/or uncovered yarn;
(x) FIG. 53 an edge portion of the bottom half and top half of a flat knit bra strap area, and is formed from a first row 128 and second row 129, where a plurality of these repeated rows within a given area of repeat knit will combine to create a double jersey knit structure, optionally wherein only uncovered yarns are used;

30. The double-knit flat-knit textile element according to any one of Clauses 23 to 27, wherein the anchoring band has a first and second knit modulus zones, where the loop length of the first zone is different from the second zone, wherein one or more of the following apply:
(i) the first knit modulus zone is placed under the first and second bra cup regions, while the second knit modulus zone is placed below the wing portion of the flat-knit bra, where the first knit modulus zone has a shorter or smaller knit loop length than the second knit modulus zone;
(ii) the first and second knit modulus zones of the anchoring band each further split into three separate modulus sub-zones, optionally wherein the sub-zones of the first knit modulus zone of the anchoring band has three different knit loop lengths compared to the sub-zones of the second knit modulus, optionally wherein the loop lengths of the first modulus sub-zones are shorter than the sub-zones of the second knit modulus,
where the zones or loop lengths are formed from one or more covered yarn.

31. The double-knit flat-knit textile element according to any one Clauses 23 to 30, wherein the first and second wing portions are knitted using a double jersey fabric structure to provide a desired fabric property, optionally wherein:
(i) the wing portion of the bra follows the stitch sequence of FIG. 30 which has first course having a front stitch and a rear stitch (54); and a second course having a rear stitch and front stitch (55), forming two courses of the bra wing portion;
(ii) the wing portion of the bra follows the stitch sequence of FIG. 29 which has first course having a front stitch (51), a second course having a front tuck rear tuck (52), and a third course having arear stitch (53) which forms three courses of the bra wing of the flat-knit bra.

32. The double knit flat-knit textile element to any one Clauses 23 to 31, wherein the fabric comprises a knit intarsia jacquard design element combining two or more colours that encompasses one or more of the bra cup, its surrounding area, straps, wing portion, bottom band and the central portion of the flat-knit bra, which is design element is formed using the stitch sequence of FIG. 54, which consists of four rows of courses, the first course (130) utilizes a miss stitch, rear stitch, Miss stitch, rear stitch, Miss stitch, rear stitch, Miss stitch, rear stitch; the second course (131) follows rear stitch, front stitch, miss stitch, front stitch, miss stitch, miss stitch, rear stitch, front stitch; the third course (132) follows a miss stitch, miss stitch, rear stitch, miss stitch, rear stitch, front stitch, miss stitch, miss stitch; and the fourth course (133) follows, a miss stitch, rear tuck, miss stitch, miss stitch, miss stitch, miss stitch, miss stitch, miss stitch, optionally wherein:
(a) the strap and cup surrounding area encompasses a rigid power line the differs from the rest of the fabric surface of the jacquard, optimally said power line uses an uncovered yarn to create the rigidity and is knitted as an intarsia technique;
(b) the intarsia jacquard design element uses both covered and uncovered yarn.

33. The double-knit flat-knit textile element according to Clause 21 or Clause 22, wherein one or more of the following apply:
(a) the central portion of the flat-knit bra adjacent to the first and second bra cup region is formed from an engineered knit provide a zipper garage, such that the central portion is split into a first and second section sections, where both of the first and second sections of the central portion each comprise a lip-like aperture having an upper and lower portion, said lip-like aperture is suitable for engagement with a means or apparatus to reversibly engage the first and second sections, optionally wherein the lip like aperture comprises an upper lip and a bottom lip, where the bottom lip extends laterally to offer comfort to the wearer and the lateral extension is formed on one or both of first and second section of the central portion, optionally the lateral extension uses a knit sequence of ten courses, as described in FIG. 56, where the first row (140) is formed as front tuck, rear tuck; second row (141) with front stitch, front stitch; third row (142) of rear stitch, rear stitch; fourth row (143) as front tuck, rear tuck; fifth row (145) of rear stitch, rear stitch; sixth row (146) of front stitch, front stitch; seventh row (147) of rear tuck, front tuck; eighth row (148) of front tuck, rear tuck; ninth row (149) of rear stitch, rear stitch; and lastly front stitch, front stitch to complete the ten courses; and
(b) the lip-like aperture follows a knit sequence of six rows of courses, optionally wherein the arrangement is as shown in FIG. 55, which is formed from a first course (134) front tuck, miss stich, rear tuck, miss stitch; second course (135) of front stitch, miss stitch, rear stich, miss stitch; third course (136) of front stitch, miss stitch, rear stich, miss stitch; fourth (137) course as miss stitch, front tuck, miss stitch, rear tuck; fifth course (138) of miss stitch front stitch, miss stitch, rear stitch; and finally (139) a knit sequence of miss stitch front stitch, miss stitch, rear stitch to complete the sixth row.

34. The double-knit flat-knit textile element according to Clause 1 or Clause 2, wherein a base fabric of the first and second bra cup regions comprises one or more of the following stitch sequences:
(i) the flat-knit bra cup zone is formed at least in part (i.e. is formed) with two distinct single jersey fabric layers that follows the knit sequence of FIG. 24, which requires a front stitch (33) and a rear stitch (34) that form two repeating courses;
(ii) the flat-knit bra cup zone is formed at least in part (i.e. is formed) with two distinct single jersey fabric layers that follows the knit sequence of FIG. 27 using courses (45)(46);
(iii) the flat-knit bra cup zone is formed at least in part (i.e. is formed) with two distinct single jersey fabric layers that follows the knit sequence of FIG. 28 using courses (47)(48)(49)(50);
(iv) the flat-knit bra cup zone is formed at least in part (i.e. is formed) with three distinct single jersey fabric layers that follows the knit sequence of FIG. 57 that follows a stitch sequence, which requires a front stitch, miss stitch (153), miss stitch, front stitch (154), miss stitch, rear stitch (155);
(v) the flat-knit bra cup zone is formed at least in part (i.e. is formed) with three distinct single jersey fabric layers that follows the knit sequence of FIG. 58 with a different stitch sequence (156) (157)(158);
(vi) the flat-knit bra cup zone is formed at least in part (i.e. is formed) with three distinct double jersey fabric layers that follows the knit sequence of FIG. 59, which follows a stitch sequence of front stitch, miss stitch, rear stitch, miss stitch, front stitch, miss stitch, rear stitch, miss stitch (159), miss stitch, front stitch, miss stitch, miss stitch, miss stitch, rear stitch, miss stitch, miss stitch (160), miss stitch, rear stitch, miss stitch, front stitch, miss stitch, rear stitch, miss stitch, front stitch (161);
(vii) the flat-knit bra cup zone is formed at least in part (i.e. is formed) with three distinct double jersey fabric layers that follows the knit sequence of FIG. 60;
(viii) the flat-knit bra cup zone is formed at least in part (i.e. is formed) with two distinct double jersey fabric layers that follows the knit sequence of FIG. 61, which follows a sequence of front stitch, rear stitch (165), rear stitch, miss stitch, front stitch, miss stitch (166) in repeating pattern;
(ix) the flat-knit bra cup zone is formed at least in part (i.e. is formed) with one double jersey and two single jersey fabric layers that follows the knit sequence of FIG. 25, which is formed with a first and second course of front stitch, rear stitch (35)(36), the third course follows a repeating knit sequence of rear stitch, miss stitch, miss stitch, miss stitch, (37); whilst a fourth course comprises of repeating knit sequence of miss stitch, miss stitch, rear stitch, miss stitch (38);
(x) the flat-knit bra cup zone is formed at least in part (i.e. is formed) with one double jersey and two single jersey fabric layers that follows the knit sequence of FIG. (22)(23)(24);
(xi) the flat-knit bra cup zone is formed at least in part (i.e. is formed) with one double jersey and two single jersey fabric layers that follows the knit sequence of FIG. 22 (28)(29)(30);
(xii) the flat-knit bra cup zone is formed at least in part (i.e. is formed) with two double jersey and one single jersey fabric layers that follows the knit sequence of FIG. 21 that uses the repeat stitch sequences of rear stitch, front stitch, miss stitch, miss stitch, rear stitch, miss stitch, rear stitch, miss stitch (25) to form the first course; a miss stitch, miss stitch, rear stitch, front stitch, miss stitch, front stitch, miss stitch, front stitch (26) to form the second course; and a miss stitch, rear stitch, miss stitch, rear stitch, miss stitch, rear stitch, miss stitch, rear stitch (27) to form the third course;
(xiii) the flat-knit bra cup zone is formed at least in part (i.e. is formed) with one double jersey and one single jersey fabric layers that follows the knit sequence of FIG. 23 (31)(32);
(xiv) the flat-knit bra cup zone is formed at least in part (i.e. is formed) with one double jersey and one single jersey fabric layers that follows the knit sequence of FIG. 26.

35. The double-knit flat-knit textile element according to any one of Clauses 1 to 3, wherein the said volume is created as follows;
(a) using the stitch sequence of FIG. 26, which provides two courses in accordance to a stitch sequence of front stitch, rear stitch (39)(40) and another four courses are created by rear stitch, miss stitch, miss stitch, miss stitch, rear stitch, miss stitch, miss stitch, miss stitch (41); and a miss stitch, miss stitch, rear stitch, miss stitch, miss stitch, miss stitch, rear stitch, miss stitch (42); which then repeats itself to form the next two courses (43)(44); and/or
(b) using the stitch sequence of FIG. 28, of the flat-knit bra follows a stitch sequence of front stitch (47), rear stitch (48), rear stitch (49), and another rear stitch (50), which forms four individual courses that splits into two layers of fabric.

36. A bra comprising the double-knit flat-knit textile element according to any one of Clauses 1 to 35.

### DRAWINGS

FIGS. 1 and 2 depict a bra as an embodiment of the current invention, split into sections A-M.

FIGS. 3 to 11 depict stitch patterns that may be used in areas A-M of the embodiment depicted in FIGS. 1 and 2.

FIG. 12A depicts a further embodiment of the invention.

FIG. 12B denoted specific regions in the embodiment of FIG. 12A.

FIG. 13 provides a key for the stitch patterns used herein.

FIG. 14 depicts a further embodiment of the current invention.

FIGS. 15-61 depicts stitch pattern sequences that may be used in embodiments of the invention (e.g. the embodiment of FIGS. 13 and 14).

### DESCRIPTION

The invention may be most generically described as one in which a flat knitted upper torso garment that is designed to be worn with or without the insertion of a removable cookie. For example, the invention may relate to a flat knitted fabric that has been fully shaped to create a flat knit bra/bralette. This will be a fully shaped unitary panel which has an anchoring band at the bottom that spreads or evolves into multiple type of layers or fabric structures or support structures. These are constructed using different knit structures and stitch sequences. The component has no three-dimensional volume created nor any knit structures that are three dimensional. The multiple fabric layers are interconnected together at the anchoring band and at the top cup area which creates a unitary knit panel. The final product may be finished by assembling the knit component with trims through cut and sew methods and further features may be added through stitching, linking or bonding.

Thus, in a first aspect of the invention, there is provided a double-knit flat-knit textile element, comprising:
a first zone comprising an anchoring band; and
a second zone comprising a first bra cup region and a second bra cup region formed from at least two layers, where the second zone is joined to the first zone by a seamless transition, wherein
   the first and the second bra cup regions formed from at least two layers comprise:
   a first layer formed as a double jersey fabric; and
   a second layer formed as a single jersey fabric.

The flat knitted textile elements (and the upper torso garments that may be produced therefrom) described herein may have one or more of the following advantages in relation to other upper torso garments. They may provide
superior coverage of the area to be covered by the garment;
extra comfort compared to conventional garments of the same type; and
support and body contouring features that may contribute to a better fit around the body of the wearer, as well as enhancing the comfort of the garment.

The main areas of a flat knitted upper torso garment encompassed by the aspect of the invention above may be described as follows:
a bottom (or anchoring) band
a cup area having multiple layers that may (or may not) be provided with the ability to insert a cookie into the bra cup;
a cup anchoring (centre-front)/zipper garage;
an apex of cup/straps;
a neckline; and
a wing area of the garment.

The above areas may be knitted as a unitary fabric that is knit-to-shape, along with edge finishing. The garment does not necessarily require any additional operations or trims to secure and finish the flat knit edges.

A textile element (and hence an upper torso garment with the above areas produced therefrom) may be knitted using covered spandex and uncovered filament yarn, or it can be knitted using staple fibers (as well as combinations of these materials). The yarn may have a core that is predefined and was used based on the functionality required by the knit component in question. For example, a predefined core yarn may be used to increase the modulus of the bottom band, while a different predefined core yarn may be used to improve the stretch and recovery of the bottom band and/or the bra wing area (it will be appreciated that combinations of such yarns may be used to provide a combination of desirable properties). Thus, the term “predefined” when used herein refers to the use of a material that has predefined properties that match the desired end use. A second type of yarn may also be incorporated into the same knit component, with this yarn being without a spandex core. This second yarn may be used on specific areas depending intended benefits and functionality desired for each area of the garment.

The flat-knit textile element component can also be finished using wash and dye methods to enhance aesthetic and performance values.

The flat-knit textile element component can also be created with logo or banding and this can be placed on the anchoring band. Though any suitable area of the textile element may be so finished.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

The products disclosed herein are based on flat knit/V-bed or weft knitting. For example, they may be produced using flat knit machines that have a minimum of two needle beds. The products are in the form of a unitary knit panel that is fully shaped to form a component of the final product.

The methods disclosed herein allow one to knit a product having one layer or multiple layers, with the ability to change the number of layers as desired while forming the product.

The flat-knit textile element has an anchoring band (or bottom band) which is at the base of the product. It helps to position the bra/bralette on the body and creates better support to the wearer. The anchoring band is knitted using both front and back bed knitting. It can also use one or more knit materials that are different from one another, or it can use the same material across the knit area. The bottom band has one set of stitches that are knit using the front bed and another that is knitted using the back bed of a flat-knit knitting machine, and it may also have a third set of stitches that runs throughout the band as transfer links between the first and second sets of stitches. More particularly, the third set of stitches may be modified to be a layer of transfer tuck stitches between the front and the back bed which are not off-set to each other and will be aligned along each needle and/or a layer of inter-tucking transfer stitches between the front and the back bed where the stitch sequences has no tuck stitches which are not off-setting each other For example, the bottom band may be formed from a double jersey construction where the first set of stitches are on the front bed, the second set of stitches are on the back bed and the two sets of stiches are linked by a transfer/tuck stitch as the third set of stitches.

Alternative options to form the bottom band include, but are not limited to:
1. an inlay method, where the first stitch sequence (or the first row of stitches) will be on the front bed, the second stitch sequence (or the second row or stiches) will be done using the back bed, and the third stitch sequence can be done by laying a yarn in between the first and second row of stitches instead of using a transfer or tuck stitch as mentioned above; or
2. using a double jersey knit structure that is knitted on the front bed as well as the back bed without any transferring tuck stitches between the two; therefore, creates an interlock double jersey knit structure.

The anchoring band then gradually transforms into at least two layers (e.g. 2, 3, 4, 5, 6) of fabric that forms the cup area of the product. These at least two layers may be referred to herein as multiple layers of fabric. These layers are seamlessly integrated to the anchoring band with flat knitting technology. They may also have different properties in terms of performance and functionality.

As noted, the second zone comprises at least a first bra cup region and a second bra cup region that are formed from at least two layers. These layers may be defined as the outer and inner layers, with the outer layer being the outermost layer of fabric that faces away from the body of a wearer and the inner layer being the innermost layer that is in direct contact with the body of a user. If there are three layers, then the third layer may be referred to as the middle layer, as it sits between the inner and outer layers. If there are more than three layers, then the layers sitting between the inner and outer layers may be described as required in order to define their relative location within the material.

The outer layer may be a double jersey fabric that uses both the front and back beds, the inner layer may be a single jersey fabric that sits next to skin and a middle layer, when present, may be a single jersey mesh fabric or be an engineered fabric form. This fabric can have multiple forms and the selection of which form (or combination of forms) to use will depend on the desired requirement for the overall garment in question. For example, the fabric may be formed in reverse to that previously described above, or in a different combination to provide increased comfort, breathability and support, depending on the desired end use. When a single jersey mesh fabric is used as the middle layer, it may be created by floating a single stitch among three needles that creates the mesh like structure. This knit area or zone of multiple layers of fabric will form the cup area as mentioned and it may have no three-dimensional knitting integrated to it. That is, the cup portions do not make use of a three-dimensional knitting pattern.

Through V-bed knitting, multiple yarns or knit materials can be associated together to create the desired multi-layer zone by the use of different knit techniques, such as intarsia knitting. This allows one to introduce a different yarn type to specific locations in the fabric by using an alternate feeder on the knit machine. This allows one to introduce specific localized colours or effect the structure of the flat knitted pattern, so as to introduce differing mechanical properties. This may allow features that will be beneficial to the end consumer to be introduced.

The second zone (i.e. the multi-layer) may spread and elongate only along a certain portion of the fabric piece (i.e. the second zone may have a limited size and shape). The two-cup region(s), which if formed from this multi-layer fabric, may be separated at the middle with a double jersey fabric. This middle parting will provide encapsulation of the breasts and will have a different stretch and recovery property than the cup area. As will be appreciated, this middle parting area may correspond with the bridge or central gore of a conventional bra, which may be referred to herein as the centre-front of a bra. In addition to the above, the subsection of the cup region where the left cup extends to the right cup area or vice versa can be separated from the middle, which is the above-mentioned knit zone. By doing so it is possible to generate two knit components that are essentially independent from each other and may allow for the generation of a zipper garage. That is, this separation point can be used as a zipper garage so that the left and right sides of the bra can be attached together. When present, the zipper garage will be fully integrated to the knit component. In order to allow for the attachment of a zipper, the unitary seamless knit will leave an opening at the top corner for zipper insertion and attachment. In embodiments where a zipper garage is present, it is possible to generate an additional fabric layer that will be next to skin of the wearer in the region of the zipper garage. This will reduce the irritation which can occur when the fabric layers are attached using the zipper in the centre-front.

The layers of the second zone may be integrated to create one single layer again at the top of the cup apex, or strap area. The knitting is done in a way that creates an aperture or opening which is integrated to the three layers (assuming three layers are present). This can be used to insert a second form of non-knit or knitted fabric piece that will help to create the bra cup (e.g. a bra cookie formed from a knitted component or a moulded foam etc.). Or else the same knitted component can be used or worn without the insertion of an additional material.

The unitary flat knit panel may also extend to create the bra wings on either side of the back panel of a bra, which may have a similar or different structure to the anchoring band.

The knit component is completed to create the final product by attaching weft knitted elastics, bra sliders & rings and hook and eye to latch either side of the back of knitted component.

As will be appreciated, V-bed knitting allows one to create a fully shaped knit panel with virtually zero waste. It also allows one to create zonal knitting that can create different knit structures and modulus zones that can be integrated seamlessly together. This will now be described by reference to a bra/bralette formed as described herein.

An anchoring band is used as the base of the product and this is a band that will extend around the body of a user when worn. This band may be a double knit structure and this portion of the fabric may have a higher modulus than the other areas of the product, while also having one or more modulus zones. As will be appreciated, when there is more than one modulus zone in the anchoring band, all of these modulus zones will have a higher modulus than other areas of the product (that is, parts of the product outside the anchoring band). This creates more stability and support to the wearer. For example, the anchoring band may have six different modulus zones that each apply a different pressure to the body of a wearer to ensure that there is a good fit and adequate support. The six different modulus zones, when present, may enable a better fit around the wearer's body (fabric won't ride up), improve performance (stability and support), and achieve a desired shape profile for the garment. As will be appreciated, the shaped knit will also reduce wastage, as minimal trimming operations are needed.

A multi-layer fabric may be used as a second zone, which comprises the bra cup regions. Portions of this multi-layer fabric may include:
An outer layer: the double jersey knit fabric creates a stable and drape-able fabric that will contour based on the wearer's body. It will also help to bring out a pleasing aesthetic to the knit product.
The middle layer (when present): this may be a perforated (mesh) knit fabric that will enhance the breathability and add to improve the modesty of the product, whilst creating a compact structure to enable the product to be worn with or without a bra cup cookie insert.
The inner layer: the single jersey or the body touching layer will be a plain knit soft touch fabric for added comfort.

The integrated Multi-layer fabric: this is at least the front portion of the bra/bralette and has been seamlessly integrated to the anchoring band (it may also relate to the back of a bra). The anchoring band is more rigid compared to the upper portion, and it transitions to create multiple forms of fabric layers which could be double jersey, mesh pointelle or single jersey. These forms of fabric have different stretch and elongation levels and as well as coverage. The machine will utilize both front and back beds when knitting multi-layer fabric component and only one or singular bed when knitting another form of fabric at the same location.

The multi-layer fabric mainly forms the area of the bra cup region, but it has no volume creation done through three-dimensional knitting. Instead, a space is created between the layers with an opening or an aperture which will enable a cookie to be inserted that will create the three-dimensional shape and provide added support and modesty to the chest area of the wearer.

An aperture may be created during the formation of the bra cup regions to allow for the insertion of the bra cookie, this aperture will seamlessly transition into the same multi-layer fabric which will then be transitioned to a double-knit fabric that will create the top portion of the upper cup region, apex, and the front strap region. The aperture is not closed and it is produced to have a clean-finished edge that does not require stitching. The aperture is relatively small and is not intended to be closed by stitching (though this would be possible if ever desired). By leaving the aperture open, the consumer has the option of taking the cookie in and out of the bra cup region.

The seamless construction of this area allows to save material and time in construction when compared to a conventional cut and sew bra/bralette and will reduce waste further due to the shaped knit form and seamless construction of most of the areas. Hence the knit component will be created as a zero-waste panel.

The multi-layer cup region can also be separated at the middle which will allow the knit component to be isolated into two knit components. The multi-layer knit will be finished as a unitary later just before the separation point before evolving into two (or more) knit layers again, allowing one to create an aperture for a zipper garage or allowing space for any other cut and sew element to be inserted. The other side of the bra knit component will also have a similar knit construction, where the lower or bottom lip of the knit fabric will be extended further to create a layer beneath the zipper tape. The lip like aperture on both sides will create the ability to minimize the number of sewing operations and the complexity that adds during a cut and sew operation.

The bra may also comprise an upper cup or apex area: the multi-layer knit portion of the cup region subsequently integrates to create a single fabric. This region has no multi-layers and has a different stretch and elongation property than the anchoring band, wings, straps, middle parting, and the cup region. This area may be integrated without any seams through the use of knit. Alternatively, this region may be made by incorporating a non-flat knit fabric or component with different fabric properties than the knit area of the anchoring band, wings, straps, middle parting, and the cup region.

Multiple zones: each of the knit components may have different areas that have inherent stretch and recovery properties. These areas may be placed to enhance the performance of the fabric which in turn will help to improve the performance of the final garment.

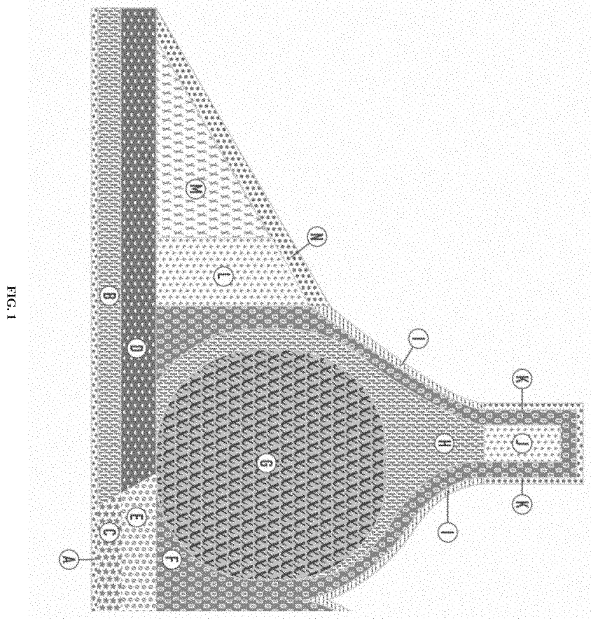

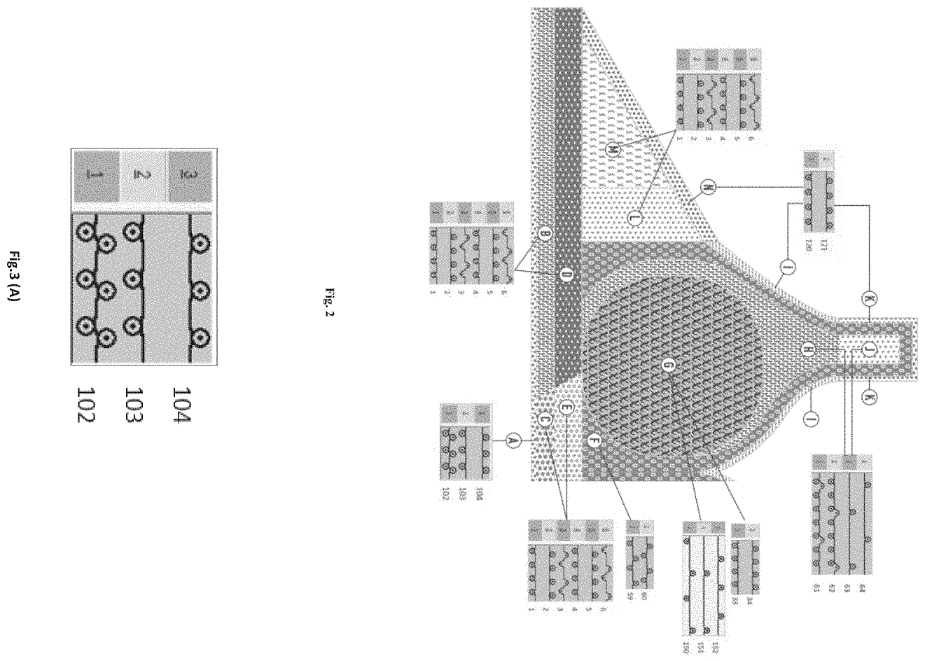

An embodiment of the invention will now be described by the attached FIGS. 1-7. This embodiment has multiple regions that have differential stitch patterns or the same stitch patterns distinguished by different mechanical properties, either by the use of different yarns and/or by the use of different loop lengths. The figure shows part of a textile element as described herein showing a bottom band (comprising sub-regions A-E) a bra cup region (G) a central portion and cup surrounding area (F), a wing (L-N) and a strap region (H-K). Further details of the stich patterns used in each zone are provided in FIGS. 2-7, while the overall embodiment is disclosed in FIGS. 1a and 1b.

As shown in FIG. 1A, there is an anchoring/bottom band, which is the stable base of the knitted bra or bra component. This knit area helps to anchor the knitted bra/bralette better on the body. The bottom band may have five different knit modulus areas namely at the bottom edge of the fabric (Region A), at the centre front (Regions C and E) and on either side of it extending to create bottom or lower portion of the front and back panel or the bra wings (Regions B and D). The difference in the modulus in each of these Regions is to better support the wearer in whichever activity they will engage in (apart from high sports performance). The centre front area (Region C and E) will help to anchor the bottom band better and help the knit component to reduce or eliminate the bounce of the breasts. The dual split zoning of the bottom band allows the knit component to have better stability on body (Region B and D).

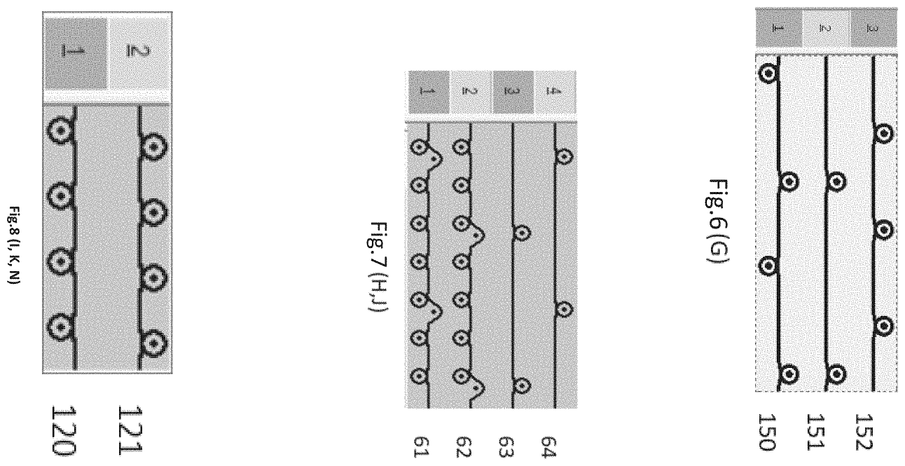

In the embodiment depicted in FIG. 1A and further illustrated in FIG. 12B, the cup region has multi-layers of interconnected fabric that cradles the wearers breasts (Region G). The outer layer is drapeable and will contour better against the wearer's body. The inner layer will sit next to the skin and the mid-layer which is mesh like will help to create better breathability and modesty for the wearer. There's also the potential for creating the bra/bralette without the middle layer depending on the requirement of the customer or need of the product. The same multi-layer zone or area can be created by using different yarn types both natural or manmade or by using blends of these yarns or yarn types. It will be appreciated that the middle layer of the multi-layer fabric can be eliminated, based on the requirement or the need associated with the particular product category in question. For example, the middle layer may be used in a bra/bralette that requires a higher degree of support, due to its desired use in vigorous activities. However, the middle layer may not be required in a bra/bralette that it intended for lounging.

As depicted in FIG. 1A, the centre front and cup surrounding area (Region F) is between the cup regions and will anchor the bra/bralette as the mid zone by helping to eliminate movement of the breasts during commute or workouts, whilst creating encapsulation of the breasts.

The same knit zone or stitch sequence extends along the multi-layer fabric that will create the bra cup region. This has more modulus or rigidity compared to the multi-layer that will enhance the support to the wearer.

The edges of the strap and the neckline may be comparatively rigid to minimize the stretch of the fabric (Regions I and K).

The centre front can also be separated so that the knit creates two individual knit components. These knit components can be the left and right of the bra. The centre front anchoring can be kept as is and an element of cut and sew element will be incorporated to the knit as described above.

As depicted in FIG. 1A, the wing area(s) may have two different modulus zones (Regions M and L) compared to the other regions of the bra/bralette. This helps to distribute the weight of the breasts around the body and limit the lateral movement of the breasts. The knit is done in a way as the wing may also carry multiple modulus or stitch zones.

As depicted in FIG. 1A, the top cup region the multi-layer fabric may be integrated to create the apex or upper cup area (Region H). This region may have multiple stitch locations and sequences and help to create more support to the wearer once worn on body.

As depicted in FIG. 1A, the strap region may have two different regions (Regions H and J) or stretch modulus areas adjoined together through knitting. These regions are seamlessly integrated and transition from one to another during the knitting process. The first region/zone or the apex (Region H) may be comparatively rigid and will give the wearer better support when the knit component is worn on body. The rigidity of this area can be defined during the knit by changing the loop length or the tension of the knit structure. The strap area may have less rigidity comparatively, but will be created with added support. That is, the second knit zone may also have more of a cushioning effect to minimize the pressure that will be felt by the wearer (Region J). This can be further improved by incorporating non knit material or using both knit and non-knit material as required.

FIG. 1B depicts the same information as FIG. 1A, but also provides details of suitable stich patterns for each of the regions disclosed herein.

FIGS. 2-7 provide details of suitable stitch patterns for each of the regions depicted in FIGS. 1A and 1B.

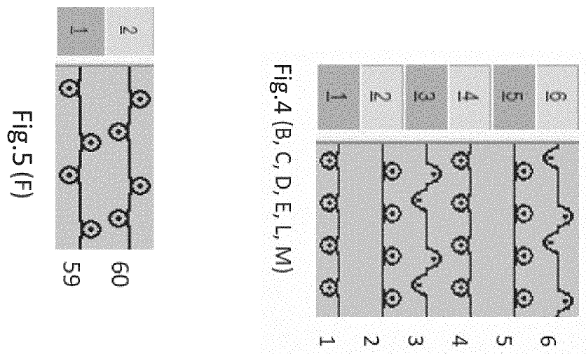

FIGS. 8-11 represent possible knit structures that may be used in certain areas of the bra.

FIG. 12 depicts a bra where the central portion between the bra cup regions can be split into two portions and house a zipper garage.

In certain embodiments, the bra cups may be moulded to provide the knit component with a 3-dimensional elevation. The fabric can be moulded to create a three-dimensional shape which will be permanent when compared to the original non-moulded fabric panel.

The addition of silicon print or silicon extrusion may also be used to change the performance of the knit product or component by keeping it in place, as it is known that the application of silicon to the inner surface of a garment may help to prevent slippage of the garment when being worn. For example, the use of silicon print can be incorporated to the anchoring band or at the edges near the apex and outer lines of the cup area.

The flat knitted bra/bralette could also be used as a loungewear or a sleepwear item

When the double-knit flat-knit textile element comprises a seamlessly integrated aperture suitable for the insertion of a bra cup cookie in the first and second bra cup regions formed from at least two layers, said aperture is not intended to be sealed, but is left open. This allows the wearer to insert or remove a bra cookie.

As mentioned herein there is provided a double-knit flat-knit textile element, comprising:
a first zone comprising an anchoring band; and
a second zone comprising a first bra cup region and a second bra cup region formed from at least two layers, where the second zone is joined to the first zone by a seamless transition, wherein
   the first and the second bra cup regions formed from at least two layers comprise:
   a first layer formed as a double jersey fabric; and
   a second layer formed as a single jersey fabric.

When used herein, the term “at least two layers” in relation to the second zone covers the possibility of using 2, 3, 4, 5, 6, 7, 8, 9 or 10 layers (i.e. multiple layers). In particular embodiments that may be mentioned herein, the second zone may include 2 to 4 layers, such as 2 or 3 layers.

While the double-knit flat-knit textile may have first and second bra cup regions formed from two layers, it is possible for other layers to be present as well (as noted hereinbefore). For example, the first and second bra cup regions formed from two layers may further comprise a third layer formed between the first and second layers, the third layer may be formed as a single jersey mesh fabric or as an engineered fabric. Further details concerning how a mesh may be formed are provided hereinbefore.

When used herein, the term “engineered fabric” refers to a fabric that may be formed using one bed of a flat knit machine that has two beds (either bed may be used) or it may refer to a fabric where both beds are used to form said fabric. The fabric will follow the same formula or method of knitting described herein. It may use both beds on certain areas and may use one of the front or back beds depending on the need of the product and the zone of the fabric. The same form of engineered fabric or a different form of engineered fabric can be knitted to any area or zone or layer as required. Said engineered fabric may be knitted using the same or different types of yarn in one or more layers or zones.

In embodiments of the invention, one or more of the following may apply:
(a) the first and second bra cup regions formed from at least two layers have an unutilised volume; and/or
(b) the textile element does not include a three-dimensional knit structure; and/or
(c) the first and second bra cup regions formed from at least two layers have an unutilised volume and the textile element is constructed so as to provide support to the first and second bra cup regions and use said unutilised volume to create a three dimensional shape when contoured against a wearer's body; and/or
(d) the textile element is constructed to provide sufficient support to the first and the second bra cup region, which uses the unutilised volume created through knit to create the three dimensional shape by contouring against a wearer's body.

As will be appreciated, when one generated a bra cup using 2-dimensional knitting, the resulting bra cup will be provided with sufficient fabric to encapsulate the breast of a wearer. However, when knitted using 2-dimensional knitting, the bra cup portion will not make use of the resulting latent volume. That is, the first and second bra cup regions formed from at least two layers have an unutilised volume. If a 3-dimensional shape is desired in the final product this may be introduced through the use a bra cookie insert, which introduces a 3-dimensional shape to the bra cup. As mentioned above, this bra cookie may be inserted to be a permanent or removable feature depending on the product line. For the avoidance of doubt, embodiments of the textile element disclosed herein does not include a three-dimensional knit structure. For example, the first and second bra cup regions formed from at least two layers may have an unutilised volume and the textile element is constructed so as to provide support to the first and second bra cup regions and use said unutilised volume to create a three dimensional shape when contoured against a wearer's body. For example, the textile element may be constructed to provide sufficient support to the first and the second bra cup region, which uses the unutilised volume created through knit to create the three dimensional shape by contouring against a wearer's body.

As noted above, the first and second bra cup regions formed from at least two layers may house a bra cup cookie that provides the first and second cup regions with a three dimensional shape configured to complement the shape of a wearer by occupying at least part of the unutilised volume of the first and second bra cup regions formed from at least two layers. In this context, the bra cup cookie provides the first and second cup regions with some free-standing 3-dimensional shape. That is, the bra cup cookie is formed to have a free standing 3-dimensional shape and when inserted into the first and second bra cup portions it will therefore provide a 3-dimensional shape to these cup portions.

In order to insert a bra cup cookie, it will be appreciated that there needs to be a hole to allow this. Thus, in embodiments of the invention the first and second bra cup regions formed from at least two layers may further comprise a seamlessly integrated aperture suitable for the insertion of a bra cup cookie. As the aperture is seamless, it is not intended to be closed and may therefore allow a user to insert and/or remove a bra cup cookie as desired.

In embodiments of the invention, the second zone may further comprise a first and second apex region around at least part of a periphery of the first and second cup regions formed from at least two layers, respectively, where each apex region is formed from a single fabric layer that is formed through a seamless transition from the at least two layers in the first and second bra cup regions. In these embodiments:
(a) the periphery of the first and second knit bra cup regions may be formed from at least two layers is completed by joining the at least two layers together by transitioning from the at least two layers to a double jersey knit (e.g. by utilising both the front and back beds of a knitting machine); or
(b) the periphery of the first and second knit bra cup regions may be formed from at least two layers is completed by joining the at least two layers together by forming a single layer fabric through a transition from the at least two layers to a single layer.

In embodiments of the invention that may be mentioned herein, the second zone may further comprise a central portion that connects the first and second bra cup regions, where the central portion is seamlessly joined to the first and second bra cup regions. This central portion may have a different stitch sequence or stitch pattern to any of the sequences/patterns in the bra cup region and the anchoring band. Additionally or alternatively, this central portion may have a different knit loop length, which gives said area a different stretch and recovery property and/or modulus, compared to the bra cup region and the anchoring band. In certain embodiments, the central portion of the second zone may be created by using at least two layers of fabric that separates the first and the second bra cup region to provide encapsulation while limiting in-and-out movement of the breasts and/or provides additional support to the anchoring band.

In embodiments of the invention, the second zone may further comprise strap portions. For example, each strap portion may be formed by knitting a first strap layer and a second strap layer, where both strap layers are formed by a double jersey structure and are connected together by one or more tuck stitches. In embodiments of this arrangement:
(i) the first and second strap layers may use different stitch sequences to provide a strap that has a cushioning effect, optionally wherein the first and second strap layers have a different modulus level at any given point, which can be predefined in the knitting sequence; and/or
(ii) the double jersey structures of the first and second strap layers may not be inlayed.

In embodiments of the invention where a central portion is present, the central portion may further comprise an extension region that surrounds at least the first and second bra cup regions and the apex portion.

In additional or alternative embodiments where a central portion is present, a loop length used in the central portion may be shorter than a loop length of adjacent regions and/or portions in the second zone, such that the central portion may be more rigid than the adjacent regions and/or portions. In particular embodiments that that may be mentioned herein, the extension region, when present, may have the same loop length as the central portion.

In embodiments that may be mentioned herein, the anchoring band may be formed from a front knit, a back knit and a tuck stitch. For example, the anchoring band may be formed from a plurality of courses where the tuck stitch changes direction after each course. In particular embodiments that may be mentioned herein, the anchoring band may have a different knit and/or stitch sequence compared to the rest of the textile element.

The anchoring band may have a first and second knit modulus zone, where a loop length of the first zone is different from the second zone. In embodiments of the invention, the second zone may further comprise wing portions. For example, each wing portion may be knitted using a double jersey fabric structure to suit a desired fabric property. In particular embodiments, the first knit modulus zone may be positioned below the first and second cup regions; and the second knit modulus zone may be positioned below the wing portions, where the first knit modulus zone has a shorter knit loop length than the second knit modulus zone. The first and second knit modulus zones of the anchoring band may each further split into three separate modulus sub-zones, optionally wherein the sub-zones of the first knit modulus zone of the anchoring band has three different knit loop lengths compared to the sub-zones of the second knit modulus, optionally wherein the loop lengths of the first modulus sub-zones are shorter than the sub-zones of the second knit modulus.

In particular embodiments of the invention, the central portion of the second zone, when present, may be divided into a first section and a second section, where the first and second sections are adapted to be reversibly engageable with one another. For example, the first section of the central portion may be formed as a lateral extension of the first bra cup region; and the second section of the central portion may be formed as a lateral extension of the second bra cup region. These regions may be formed in any suitable manner. For example:
(a) each of the first and second bra cup regions may terminate in a single unitary layer from with the lateral extension of the first and second sections, respectively, of the central portion are formed; and/or
(b) the first and second sections may be independently formed as a single jersey knit and/or a double jersey knit.

More particularly, the first and second sections of the central portion may each comprise a lip-like aperture having an upper and lower portion, said lip-like aperture may be suitable for engagement with a means or apparatus to reversibly engage the first and second sections. For example, the means or apparatus to reversibly engage the first and second sections may be a zipper. In particular embodiments, one or more of the following may apply:
(a) the loop length of the upper lip portion may be different to the loop length of an adjacent portion of the cup region and from the loop length of the bottom lip portion;
(b) the loop length of the bottom lip portion may be different to the loop length of an adjacent portion of the cup region and from the loop length of the upper lip portion;
(c) the bottom lip portion may be formed using a single jersey knit or a double jersey knit;
(d) the upper and bottom lip portions may be formed to have a clean finished edge that requires no seaming operations; and
(e) the lip-like apertures may house a zipper.

As will be appreciated, the double-knit flat-knit textile element may be used to provide a bra. Thus, there is also disclosed in a second aspect of the invention a bra comprising the double-knit flat-knit textile element as described herein. This bra (or torso garment) may contain fourteen different modulus levels.

A further embodiment of the invention will now be described by reference to the following areas of a bra that may be formed using the textile element disclosed herein. These areas may be grossly defined as:
Bottom band
Cup area-multilayer with cookie insertion
Cup anchoring (center front)/Zipper garage
Apex of cup/Straps
Neckline
Wing area of the bra

Bottom Band

The bottom band (or anchoring band) may be knitted as a double jersey structure using both beds of a flatbed knit machine. One set of courses knitted on the front bed and the other on the back bed. The front and back bed stitches may then be connected using a tuck stitch which runs between the front and back beds of the knit machine. The above-mentioned structure can be used to create a seamless multi modulus bottom band, where the differences in modulus can be introduced by the use of different knit loop lengths across the band.

The bottom band then transfers and extends into the left and right cup area of the knit component and to the wing area from the sides. This transition is seamless. The transition is then extended to a multi-layer fabric in the left and right cup area. The bottom band can be knitted using one or more yarn types which has or have the same or different spandex core or a covered yarn around it. The outer layer may be knitted using one type of a covered yarn that will exist in as the inner layer as well. The above yarn will be knitted using the back and front beds. A second type of covered yarn may be used for the inter-tucking stitch sequence. The combination of these stitches and sequences will create the full bottom band which has multiple modulus zones due to variations of knit loop lengths. The bottom band can carry a logo or branding, which may consume yarns of different colour or colours.

The bottom band may have the highest level of modulus, which also splits into two regions. The first region being below the left and right breasts and the second region under the wing area. The two regions may further split into three distinct modulus levels to enable the anchoring of the bra to fit the frame of the wearer. As discussed hereinbefore, such as with respect to FIG. 1A and further illustrated in FIG. 12A.

Cup Area

The cup area is created by extending the bottom band into multiple layers. The innermost layer and the outermost layer may detach from each other to create an aperture for the cookie insertion that can be either at the bottom of the cup area or at the side of the cup area depending on the requirement. There will be a minimum of two layers, but this can be extended up to three or more (as noted above). The outer layer may be knitted using covered or uncovered yarns. The yarn may be knitted on both front and back beds to create a double jersey structure or will us a single bed when knitting a single jersey fabric as the outer layer.

The innermost layer can either be a single jersey or a double jersey. This layer may be knitted using the same yarns that were used for the outer layer, or it may use an entirely different yarn depending on the desired end use. For example, it may be desired to use a yarn that will provide a soft skin-feel when next to the body, which might not be possible using the yarn used for the outermost layer.

Slight volume may be created by flat knitting a fabric using flecharge knitting at the innermost layer which creates encapsulation for the breasts.

A third layer, when present, may be knitted in between the inner and the outer layers as a single jersey or double jersey fabric. This may use the same yarns that were used for the outer layer or to use a new yarn depending on the end use. The third layer when present may be used for nipple concealment in a bra.

Areas adjacent and surrounding the cup area may be knitted as a non-layered double jersey and this region may be a multi-modulus zone. For example, the zone between the right and left cups may have two modulus areas, one which extends from the neckline and the second brought up from the bottom band. The zone which extends from the bottom band may have the same modulus level as the areas on either side of the left and right bra cups. The double jersey can carry mesh wholes or perforation within the double jersey knit structure.

Within the cup region, the innermost layer contours to the shape of the breast and holds the highest modulus level compared to the other parts of the cup region. The outermost layer provides additional support to the innermost layer and holds a different modulus level than its counterparts (i.e. it has a lower modulus than the innermost layer, but a higher modulus than a middle layer). The middle layer may have the lowest modulus level and works to add more mass to the shape of the cup (e.g. to provide nipple concealment).

The areas surrounding the cup region may make use of a suitable modulus level that cradles the cups and provides the desired support. This region may be knitted using a particular stitch sequence.

Zipper Garage

The zipper garage may be knitted using the adjacent double jersey fabric of the fabric cup area. In this case, the double jersey fabric may be split into two creating a garage to encase the zipper. This allows one to eliminate skin irritation/chafing and additional seams.

The outer layer of the garage may have a heat soluble yarn or TPU on the inner side of the outer layer. This will be plated onto the double jersey spacer to create additional rigidity.

The left-side portion of the same structure may be extended further which is the closest to body. This is another double jersey which has a set of front courses and a set of back courses knitted on the front and back beds which has an interconnecting tuck stitch. This extended portion of the fabric may be included to help avoid skin irritation that could potentially be causes by the zipper.

Neckline and Armhole

This region may be formed using a double jersey flat knit that has edge finishing (clean finished) along the periphery of the knit, which may be knit to shape. These apertures consist of a double jersey knit structure or tubular knit; the knit loop length varies depending on the performance attributes of the final knit product, where the outer most set of wales are knitted to secure the edge from unravelling and to give a better finish. The next set of wales may have a higher modulus due to a different knit loop length and structure which enables better fit and support to the wearer. Depending on the requirement of the customer the knit component can be given a facelift by adding a rib structure/mesh/ripple or any other double jersey knit structure to enhance the aesthetics of the final product.

The neckline provides a modulus level above the left and right cup regions that can be customized according to the support requirement of the wearer and the activity in question. The flatknit fabric works as a reinforcement to fortify support, fit and further facilitates the design as an aesthetic feature. Generally, having a higher neckline allows higher support than lower necklines. The neckline has a lower modulus level relative to the anchoring band.

Strap

The strap may be knitted as a double jersey which incorporates a dual modulus area; where the first shares the same knit structure and stitch sequence of the periphery of the cup fabric.

The modulus levels of the straps aid to lift and secure the breasts of the wearer that limits up-down movements. It is split into two parts, where the bottom half of the strap has a higher modulus than its upper half. The bottom half and the upper half of the strap may have a higher modulus than the adjacent cup region.

Wing

The wing can be knitted either as a spacer/interlock/rib/mesh or any other double jersey structure. The flat knit fabric on the wing area may use the flecharge knitting method to achieve a slanted shape which provides support to the surrounding muscles of the wearer and may give way to an aesthetically pleasing design. The edge of the flatknit fabric may be a tubular knit and a bind off technique may be used to create a smooth margin.

The third highest modulus level may be present in the wing area to provide side and back support to the wearer. This portion of the flatknit fabric fits around the body of the wearer and provides the most widespread support that holds the entire bra in place.

Modulus Regions

FIG. 12A-B depict various modulus levels that may be present in parts of a bra formed according to the currently claimed invention.

As noted herein, bottom band carries the highest level of modulus, and it may also be splits into at least two regions. The first region may be below the left and right breasts (AA)(A.1)(A.2)(A.3) and the second under the wing area (AAA)(A.4)(A.5)(A.6). These two regions may each further split into three distinct modulus levels (for AA, see (A.1)(A.2)(A.3); for AAA see (A.4)(A.5)(A.6)) to enable the anchoring of the bra to fit the frame of the wearer.

It will be appreciated that all of these modulus levels are higher than that present in all other regions.

Wing

The third highest modulus level is present in the wing area (C) to provide side and back support to the wearer. This flat knit fabric that fits around the body of the wearer provides the most widespread support that holds the entire bra in place.

Strap

The modulus level of the straps aid the lift provided by the bra and also secure the breasts of the wearer that limits up-down movements. It is split into two parts where the topmost portion of the straps (F.2) has a lower modulus level than its bottom half (E). Further, the boundary of the strap zone (F.1) generates a different modulus level than the rest of the flat-knit bra. These different modulus levels are created due to the changes in yarn type which can either be covered or uncovered or a combination of both or by changing the length of the stitch or stitch sequence.

Neckline

The neckline provides a modulus level (D) above the left and right cup regions which can be customized according to the support requirement of the wearer and the activity. This part of the flat knit fabric works as a reinforcement to fortify support, fit, and may further facilitate the presence of an aesthetic design feature. As will be appreciated, having a higher neckline allows for higher support than lower necklines. This is the second highest modulus area of the flat knit bra or knitted fabric.

Cup

As noted in FIG. 12B, the cups may have three layers. The innermost layer (B.1) contours to the shape of the breast and holds a medium support level compared to the other two layers. The outermost layer (B.3) provides additional support to the innermost layer and holds a different or the highest modulus level compared to the other layers. The middle layer (B.2) has the lowest modulus level and works to add more mass to the shape of the cup and also improves modesty by adding an extra layer of fabric, thereby helping to obscure the nipples further.

The inner most fabric layer and the outer layer may be interchangeable by way of structure and modulus.

Areas Surrounding the Cup Region

The modulus level on this region (E) cradles the cups and provides the desired support and is knitted using a particular stitch sequence.

The following areas enables the limitation of breast motion by collectively acting towards prevention of the same. The bottom band and the neckline along with the strap aids in minimizing the up-down movements of the breasts, whereas the cup region (left and right) and the center front portion of the flat knit fabric aids in minimizing the in-out movements. Additionally, the wing portion and the area between the cup and the wing (the area outside the cup region) limits side-side movements. Therefore, the wearer may benefit from all of the support structures during physical activity to reduce or prevent breast motion.

Specific modulus levels that may be suitable for each of the regions identified in FIGS. 12A-B will now be listed below in Tables 1 and 2.

TABLE 1

| Region | Modulus Level | Range |
|---|---|---|
| A1 | 2.1-2.4 | High |
| A2 | 2.05-2.36 | High |
| A3 | 2.0-2.3 | High |
| A4 | 2.0-2.3 | High |
| A5 | 1.95-2.25 | High |
| A6 | 1.9-2.2 | High |
| C | 1.5-1.8 | Medium |
| E | 1.1-1.4 | Low |
| D | 1.7-2.0 | Medium |
| F.1 | 1.0-1.3 | Low |
| F.2 | 1.0-1.3 | Low |
| B | 0.9-1.2 | Low |

TABLE 2

| Region | Modulus Level | Range |
|---|---|---|
| B.1 | 0.85-1.15 | Low |
| B.2 | 0.80-1.10 | Low |
| B.3 | 0.9-1.2 | Low |

Stitch Nomenclature

In the figures disclosed herein, there may be reference to stitching patterns. The nomenclature used in these patterns is summarised in FIG. 13. Stitch sequences are described according to the knit direction.

### Further Embodiment

A further set of embodiments will now be described by reference to FIGS. 14 to 56.

FIG. 12A represents a bra that is formed from a first and second zone as described hereinbefore, where the first zone corresponds to region A (AA(A1,A2,A3)(AAA(A4,A5,A6)), and the second zone corresponds to regions B-F.2. Each of these regions will now be discussed, along with options for the stitch sequences that may be used in each region.

Zone A (Anchoring, or Bottom Band)

The anchoring (or bottom) band may be formed from a number of different stitch sequences. These are depicted in FIGS. 15 to 19.

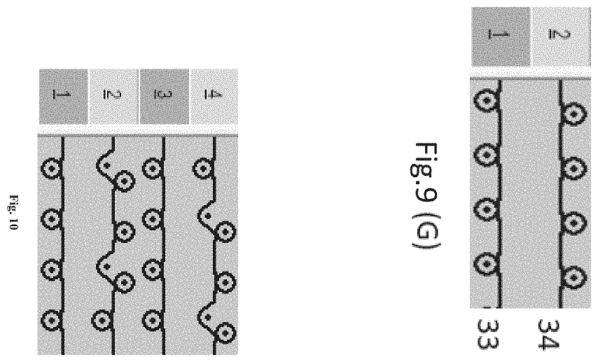

In FIG. 15, the stitch sequence for at least a portion of the flat-knit bra bottom band zone includes a first row, second row, third row, fourth row, fifth row and a sixth row. Accordingly, the first row and second row (1, 2 referring to the right hand side (RHS) numbering) as well as the fourth row and fifth row (4, 5 RHS) may be knitted to provide a course of front stitch followed by a course of rear stitch. Alternatively, in FIG. 16, a course of rear stitch (7, 10 RHS) may be followed by a course of front stitch (8, 11 RHS) in the knit sequence. In these embodiments, the bottom band zone may include a third row (3, 9 RHS) which uses a stitch sequence of rear tuck, front tuck in the repeating pattern, and a sixth course comprising of a front tuck, rear tuck (6, 12 RHS) in the repeating pattern. The stitch sequence may further make use of needles I, II, Ill, and IV as part of a repeating pattern, V (only shown in FIG. 15, but applicable to FIGS. 16-19 too).

In some instances, the flat-knit bottom band zone stitch sequence may comprise of a repeating pattern of front stitch, rear stitch (13 RHS) to form one course of interlock fabric and a further stitch sequence of rear stitch, front stitch (14) repeating pattern to form another course of interlock fabric (see FIG. 17). This may be used alone or in addition to the courses set out in FIGS. 15 and 16.

Additionally, as shown in FIG. 18, the flat-knit bottom band zone may include courses formed from a front stitch (15 RHS), front tuck rear tuck (16), and a rear stitch (17). Alternatively, as shown in FIG. 19, four courses of spacer fabric may be knitted using a stitch sequence of front tuck rear stitch (18), front stitch (19), front stitch rear tuck (20), and rear stitch (21).

These patterns may be repeated across the entire bottom band zone. It is noted that one knit sequence can accommodate all six different modulus levels in the bottom band. This may be achieved by varying the knit loop length, which allows one to attenuate the modulus (as well as the stretch and recovery) at any given point. An additional yarn can also be introduced to create additional support to the wearer of the garment, should this be required/desired. Therefore, one of the stitch sequences above can be used alone in the bottom band to provide the desired modulus levels. Alternatively, two or more of the stitch sequences above may be selected to be present in the bottom band—either because their inclusion allows for the generation of the desired modulus levels without variation of the loop length and/or because they provide different properties to the band that may benefit the end user (in the latter case the loop lengths may still be varied).

In some aspects, a spandex covered yarn may be used to knit the bottom band may, with the assistance of the stich sequence patterns outlined herein, form a high power zone with a modulus level that generates a high degree of stretch and recovery. As will be appreciated, such features may form a vital requirement of the bottom band.

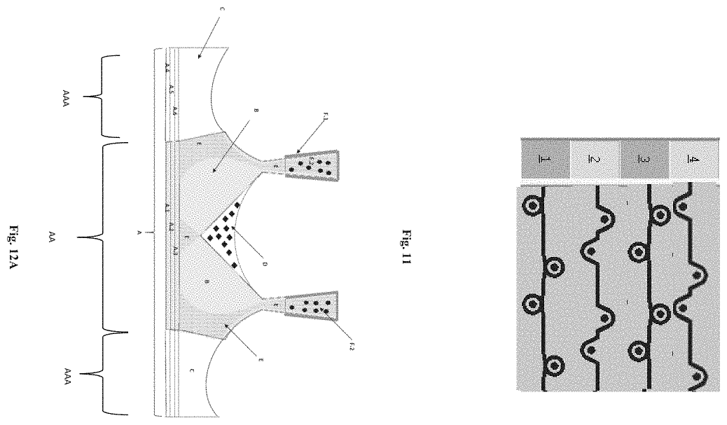

Bra Cup FIGS. 20-28 and 57-61

FIG. 20 depicts a stitch sequence for at least one portion of the flat-knit bra cup region, which includes a front stitch, miss stitch, rear stitch, miss stitch, front stitch, miss stitch, rear stitch, and a miss stitch (22, RHS) that forms one course of the flat-knit fabric. The next course is created by a miss stitch, front stitch, miss stitch, miss stitch, miss stitch, front stitch, miss stitch, miss stitch (23, RHS) and a third course is formed by a miss stitch, rear stitch, miss stitch, rear stitch, miss stitch, rear stitch, miss stitch, rear stitch (24, RHS). This knit sequence is repeated to create three layers of the bra cup with one layer of a double jersey fabric (22) and two layers of single jersey fabric (23)(24).

FIG. 21 depicts part of a flat-knit bra cup zone stitch sequence with three courses that uses the repeat stitch sequences of rear stitch, front stitch, miss stitch, miss stitch, rear stitch, miss stitch, rear stitch, miss stitch (25, RHS) to form the first course; a miss stitch, miss stitch, rear stitch, front stitch, miss stitch, front stitch, miss stitch, front stitch (26, RHS) to form the second course; and a miss stitch, rear stitch, miss stitch, rear stitch, miss stitch, rear stitch, miss stitch, rear stitch (27, RHS) to form the third course. This results in a material having two double jersey fabric layers and one single jersey fabric layer.

FIG. 23 depicts part of a flat-knit bra cup zone stich sequence that includes a front stitch, rear stitch (31, RHS) to form one course and rear stitch, miss stitch (32) to form the next. This stitch sequence may be used to in the cup surrounding area and bottom half of a strap and so does not form part of the bra cup itself. This results in a material having one double jersey fabric layer and one single jersey fabric layer. Alternatively, FIG. 22 shows that there may be three courses and the third course will be added in the middle of the first two courses (28,30 RHS) comprising of a miss stitch and front stitch (29. RHS). This results in a material having one double jersey fabric layer and two single jersey fabric layers.

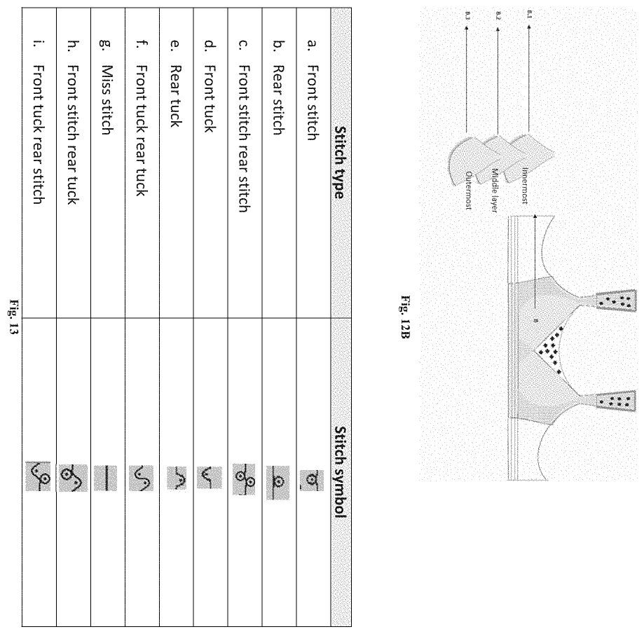

FIG. 24 depicts part of the flat-knit bra cup zone that may be formed with two distinct fabric layers which follows the knit sequence of front stitch (33, RHS) and rear stitch (34, RHS) that form two repeating courses. This results in a material having two single jersey fabric layers.

In other areas or in a different embodiment, two courses in at least one portion of the flat-knit bra cup zone may be formed with a front stitch, rear stitch (35, 36 RHS), the third course follows a repeating knit sequence of rear stitch, miss stitch, miss stitch, miss stitch, (37 RHS); whilst a fourth course comprises of a repeating knit sequence of miss stitch, miss stitch, rear stitch, miss stitch (38 RHS). See FIG. 25, this results in a material having one double jersey fabric layer and two single jersey fabric layers.

Another stitch sequence, as depicted in FIG. 26, provides two courses in accordance to a stitch sequence of front stitch, rear stitch (39, 40 RHS) and another four courses are created by rear stitch, miss stitch, miss stitch, miss stitch, rear stitch, miss stitch, miss stitch, miss stitch (41, RHS); and a miss stitch, miss stitch, rear stitch, miss stitch, miss stitch, miss stitch, rear stitch, miss stitch (42, RHS); which then repeats itself to form the next two courses (43, 44 RHS). This results in a material having one double jersey fabric layer and one single jersey fabric layer.

The stitch sequence depicted in FIG. 27, may be used to create layers of the bra cup zone of the flat-knit bra, that consists of two rows; the first row is formed by a miss stitch and front stitch (45, RHS); while the second row consists of a rear stitch and miss stitch (46, RHS). This results in a material having two single jersey fabric layers.

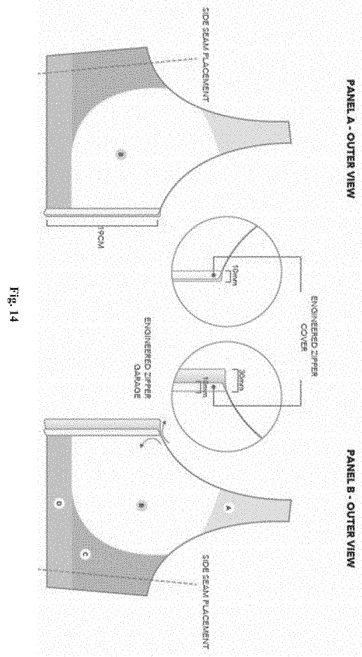

The bra cup zone may also use the stitch sequence of FIG. 28, which follows a stitch sequence of front stitch (47, RHS), rear stitch (48), rear stitch (49), and another rear stitch (50), which forms four individual courses that splits into two layers of fabric. This results in a material having two single jersey fabric layers.

Finally, the bra cup zone of each aspect of the flat-knit bra discussed thus far may use two yarns: a covered and an uncovered yarn. The first yarn, which is covered, creates high elasticity and stretch recovery to fit the fabric well against the wearer. The second yarn, which is uncovered, generates traction and contours the fabric against the wearer's body to enable an exemplary fit. In another instance, the bra cup zone may utilize one yarn, which is uncovered, to create a double layer of fabric that grips the body of the wearer and generates an exemplary profile.

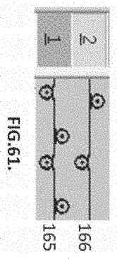

FIGS. 57 and 58 depict stitch sequences that may be used to form a flat knit bra cup zone having three single jersey fabric layers.

FIGS. 59 and 60 depict stitch sequences that may be used to form a flat knit bra cup zone having three double jersey fabric layers.

FIG. 61 depicts a stitch sequence that may be used to form a flat knit bra cup zone having two double jersey fabric layers.

Bra Wing—FIGS. 29-30

The stitch sequence depicted as FIG. 29, makes use of a front stitch (51, RHS), front tuck rear tuck (52), and a rear stitch (53) which forms three courses of the bra wing of the flat-knit bra. Alternately, another variation may include, as shown in FIG. 30, a front stitch and a rear stitch (54); and a rear stitch and front stitch (55), forming two courses of the bra wing portion.

The wing of the flat-knit bra utilizes a covered yarn to generate the desired material qualities such as high stretch and recovery, and high modulus levels to enable better fit and grip towards the wearer's body.

Cup Surrounding Area—FIG. 31-36

The cup surrounding area may be formed using one or more of the following patterns. These patterns may have a double jersey structure.

FIG. 31, formed from courses 56, 57,58 (RHS). FIG. 32 formed from courses 59, 60 (RHS).

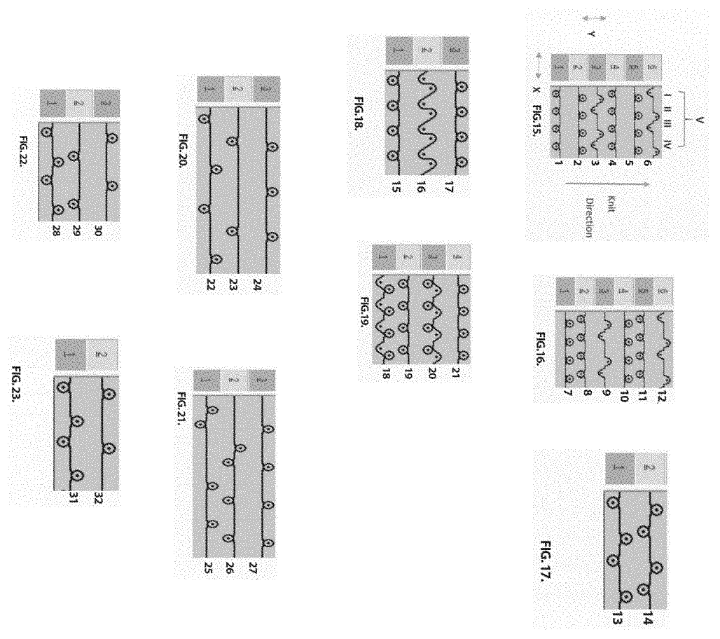

The patterns depicted in FIG. 33 may be used in the periphery of the multilayer cup region of the flat knit bra component. This pattern is formed using the knit 1st row 61 (RHS), second row 62, third row 63 and the fourth row 64. This knit zone can be knitted using one more type of yarn which could be an elastic covered yarn or an uncovered version of the same yarn type.

FIG. 34 formed from courses 65, 66, 67, 68 (RHS).

FIG. 35 depicts a pattern that may be used in the centre front area of a flat knit bra component and uses the knit sequence of 1st row 69, second 70, third 71 and fourth 72 (RHS).

This zone can either carry one yarn type or two yarn types which can be a combination of covered and/or uncovered yarns. The knit loop length of this area can vary depending on the support level required by the product.

FIG. 36, which depicts a pattern having 1st row 73, second row 74, third row 75 and fourth row 76 (RHS), which can also be used to knit this double jersey knit structure.

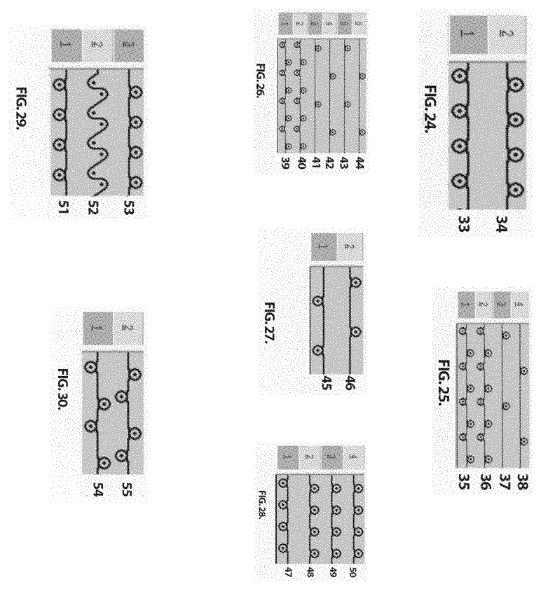

Neckline—FIG. 37-43

The neckline provides a modulus level above the left and right cup regions that can be customized according to the support requirement of the wearer and the activity that the bra is designed to deal with. The flatknit fabric works as a reinforcement to fortify support and fit. It may also be used as an aesthetic design feature. Having a higher neckline allows higher support than lower necklines. This is the second highest modulus area of the flat knit bra or knit fabric.

The stitch sequence of FIG. 37 may be found at the edge of a flat knit bra neckline zone includes 1st row 77 (RHS), second row 78, third row 79 and fourth row 80. The above-mentioned courses with miss stitch, front stitch, front tuck, rear tuck, and rear stitch adds up to a flat knit double jersey spacer structure. The above mentioned knit sequence can be knitted using covered and uncovered yarns

The stitch sequence in FIG. 38, which may be adjacent to FIG. 37 in a knit bra neckline zone includes 1st row 81, second row 82, third row 83 and fourth row 84 (RHS). The above-mentioned courses add up to a flat knit double jersey spacer structure which has a different knit loop length compared to FIG. 37 and may be knitted using covered and uncovered yarns.

The stitch sequence FIG. 39 can also be used at a knit bra neckline zone including 1st row 96, second row 97 (RHS) using only uncovered yarn.

In addition to the knit sequences given above, the adjacent area of the flat knit bra neckline zone can be knitted using the below stitch sequences on a flat knit V-bed machine utilizing both covered and uncovered yarn types or either one of them.

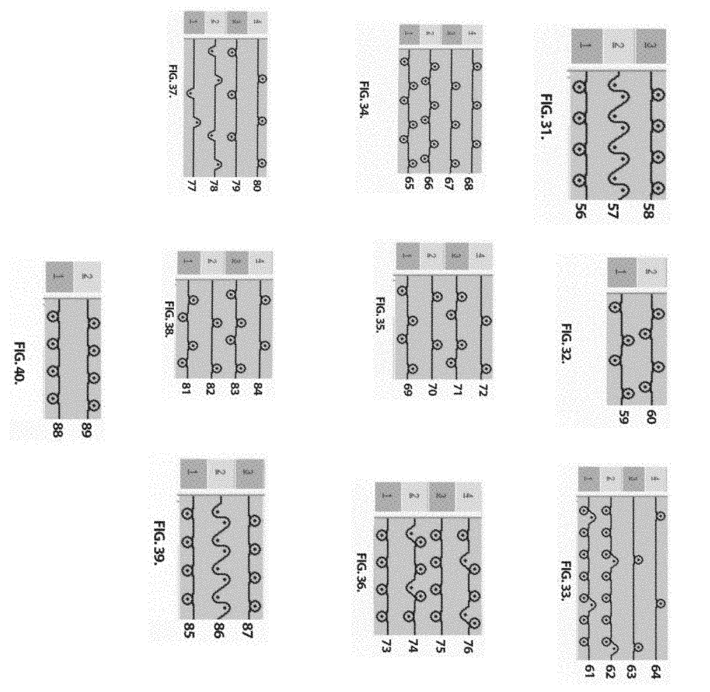

The following stitch sequences may also be placed adjacent to the stitch sequence in FIG. 37:
The stitch sequence FIG. 40 includes 1st row 85, second row 86, third row 87;
FIG. 41 includes 1st row 88, second row 89;
FIG. 42 includes 1st row 90, second row 91, third row 92, fourth 93; or
FIG. 43 includes 1st row 94, second row 95.

These above patterns can be used to create a double jersey spacer knit.

Strap—FIG. 44-53

The stitch sequence FIG. 44 may be used at the middle portion (bottom half and top half) of a flat knit bra strap area is formed from a 1st row (98) rear tuck, front tuck (99, RHS) second row; front stitch, rear stitch; and a third row (100) in front tuck, rear tuck; and finally, a fourth row (101) of rear stitch, front stitch. The above-mentioned courses and a plurality of them with a given area of repeat knit will combine to create a double jersey spacer knit structure on a flatbed V-bed machine and can be knitted using covered and uncovered yarn.

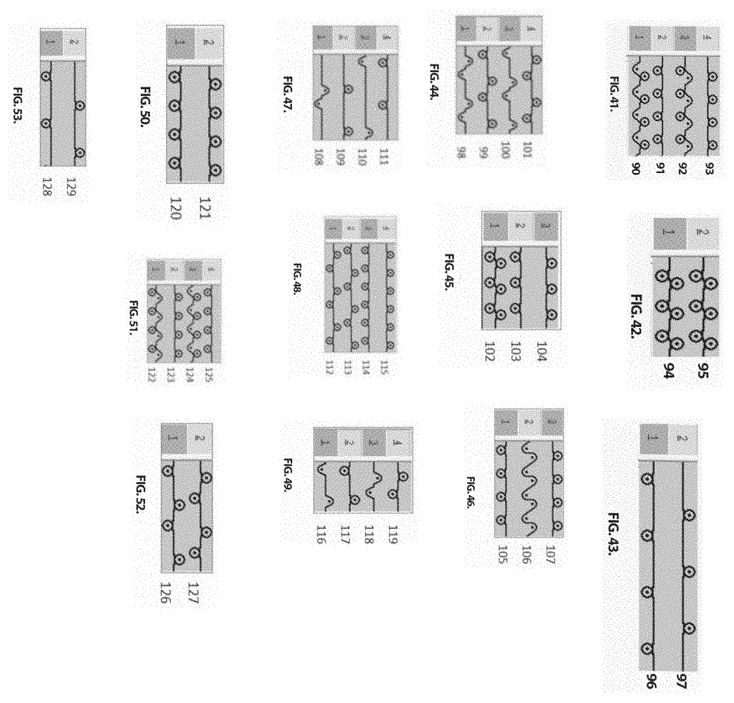

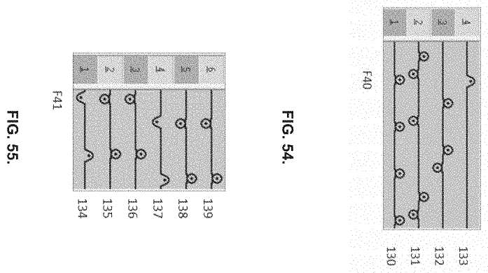

Additionally or alternatively one or more of the following stich sequences may be used in the middle portion of a flat knit bra strap area:
FIG. 45 is formed from a 1st row 102, second row 103, third row 104;
FIG. 46 is formed from a first row 105, second row 106, third row 107;
FIG. 47 is formed from a first row of (108) miss stitch, rear tuck, front tuck, miss stitch; second row of (109) miss stitch, rear stitch, miss stitch, rear stitch; third row (110) as front tuck, miss stitch, miss stitch, rear tuck; fourth row (111) of front stitch, miss stitch, front stitch, miss stitch;
FIG. 48 is formed from a first row 112, second row 113, third row 114, fourth row 115;
FIG. 49 is formed from a first row 116, second row 117, third row 118, fourth row 119;
FIG. 50 is formed from a first row 120, second row 121;
FIG. 51 is formed from a first row 122, second row 123, third row 124, fourth row 125; or
FIG. 52 is formed from a first row 126, second row 127,

which will create a double jersey spacer knit structure for the flat knit bra strap.

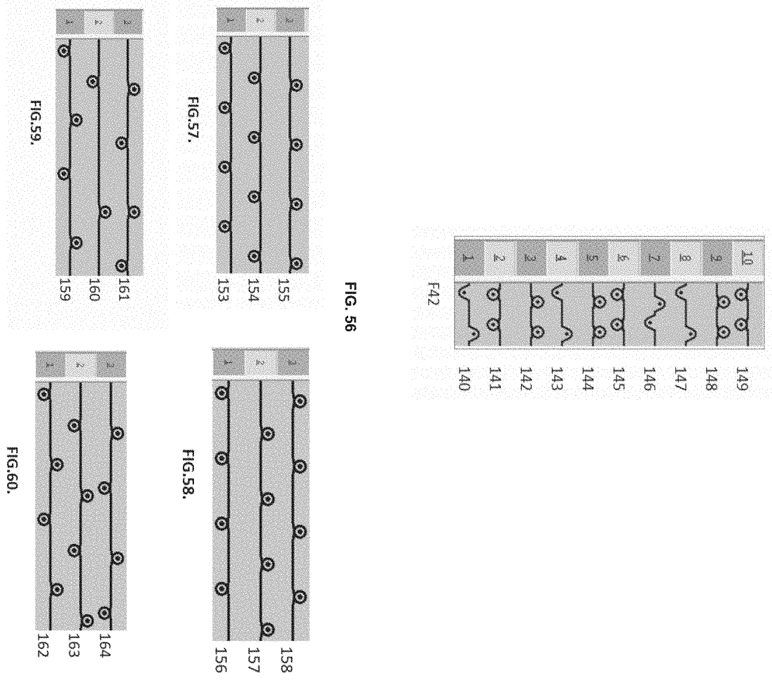

The stitch sequence FIG. 53 may be used at the edge of a flat knit bra strap area and is formed from a 1st row 128, second row 129. The above-mentioned courses and a plurality of them within a given area of repeat knit will combine to create a double jersey knit structure on a flatbed V-bed machine and this may be knitted using only uncovered yarns.

Additionally or alternatively, the stitch sequences depicted in FIGS. 45, 46, 48, 49, 51 & 52 may be used in the middle of the strap of the flat knit bra/bralette. The stitch sequence illustrated in FIG. 47 may be used at the edge of the strap of the flat knit bra/bralette. Furthermore, FIG. 50 may be used in both areas of the strap middle portion and the edge/boundary of the strap area of the flat knit bra/bralette. The above stitch sequences may be knitted on a flat knit V-bed machine utilizing covered and/or uncovered yarn types.

Jacquard Design for Bra Cup, Surrounding Area and Strap—FIG. 54

FIG. 54 relates to a method of creating a knit intarsia jacquard design element combining two or more colours; which encompasses the bra cup, its surrounding area, straps, wing portion, bottom band as well as the central portion of the flat-knit bra; and consists of four rows of courses. First course (130) utilizes a miss stitch, rear stitch, Miss stitch, rear stitch, Miss stitch, rear stitch, Miss stitch, rear stitch; where the second row (131) follows rear stitch, front stitch, miss stitch, front stitch, miss stitch, miss stitch, rear stitch, front stitch; thirdly (132) a miss stitch, miss stitch, rear stitch, miss stitch, rear stitch, front stitch, miss stitch, miss stitch; and lastly (133), a miss stitch, rear tuck, miss stitch, miss stitch, miss stitch, miss stitch, miss stitch, miss stitch. As will be appreciated, the product will show this stitch pattern.

Central Portion: Engineered Zipper Garage—FIG. 55-56

The central portion of the flat-knit bra adjacent to the first and second bra cup regions, may use an engineered knit method to create a zipper garage. In this case, the central portion may be split into two separate sections. Each of the first and second sections of the central portion may each comprises a lip-like aperture having an upper and lower portion; said lip-like aperture suitable for engagement with a means or apparatus to reversibly engage the first and second sections.

The said lip-like aperture follows a knit sequence of six rows of courses. Such an arrangement is depicted in FIG. 55, which is formed from a first course (134) front tuck, miss stich, rear tuck, miss stitch; second course (135) of front stitch, miss stitch, rear stich, miss stitch; third course (136) of front stitch, miss stitch, rear stich, miss stitch; fourth (137) course as miss stitch, front tuck, miss stitch, rear tuck; fifth course (138) of miss stitch front stitch, miss stitch, rear stitch; and finally (139) a knit sequence of miss stitch front stitch, miss stitch, rear stitch to complete the sixth row.

Where the lip like aperture comprises of a upper lip and bottom lip; the said bottom lip may further extend laterally to offer comfort to the wearer; the lateral extension may be formed on either side of the two sections of the central portion; and may created using the following knit sequence of ten courses, as depicted in FIG. 56, where the first row (140) is formed as front tuck, rear tuck; second row (141) with front stitch, front stitch; third row (142) of rear stitch, rear stitch; fourth row (143) as front tuck, rear tuck; fifth row (145) of rear stitch, rear stitch; sixth row (146) of front stitch, front stitch; seventh row (147) of rear tuck, front tuck; eighth row (148) of front tuck, rear tuck; ninth row (149) of rear stitch, rear stitch; and lastly front stitch, front stitch to complete the ten courses.

In embodiments disclosed herein, the following areas enables the resulting bra to limit breast motion by collectively acting towards its achievement. The bottom band and the neckline aids in minimizing the up-down movements of the breasts; whereas the cup region (left and right) and the centre front portion of the flat knit fabric aids in minimizing the in-out movements. Additionally, the wing portion and the area between the cup and the wing (the area outside the cup region) limits side-side movements. Whereby, the wearer is benefitted in all support structures during physical activity.

1. A double-knit flat-knit textile element, comprising:
a first zone comprising an anchoring band; and
a second zone comprising a first bra cup region and a second bra cup region formed from at least two layers, where the second zone is joined to the first zone by a seamless transition, wherein
the first and the second bra cup regions formed from at least two layers comprise:
a first layer formed as a single or a double jersey fabric; and
a second layer formed as a single or a double jersey fabric.

2. The double-knit flat-knit textile element according to claim 1, wherein the first and second bra cup regions formed from at least two layers further comprise a third layer formed between the first and second layers, the third layer formed from one or more of the group consisting of a single jersey fabric, a double jersey fabric, an engineered fabric and a single jersey mesh fabric.

3. The double-knit flat-knit textile element according to claim 1, wherein:
(a) the first and second bra cup regions formed from at least two layers have an unutilised volume; and/or
(b) the textile element does not include a three-dimensional knit structure; and/or
(c) the first and second bra cup regions formed from at least two layers have an unutilised volume and the textile element is constructed so as to provide support to the first and second bra cup regions and use said unutilised volume to create a three dimensional shape when contoured against a wearer's body; and/or
(d) the textile element is constructed to provide sufficient support to the first and the second bra cup region, which uses the unutilised volume created through knit to create the three-dimensional shape by contouring against a wearer's body.

4. (canceled)

5. The double-knit flat-knit textile element according to claim 1, wherein the first and second bra cup regions formed from at least two layers further comprise a seamlessly integrated aperture suitable for the insertion of a bra cup cookie.

6. The double-knit flat-knit textile element according to claim 1, wherein the second zone further comprises a first and second apex region around at least part of a periphery of the first and second cup regions formed from at least two layers, respectively, where each apex region is formed from a single fabric layer that is formed through a seamless transition from the at least two layers in the first and second bra cup regions.

7. The double-knit flat-knit textile element according to claim 1, wherein the second zone further comprises a central portion that connects the first and second bra cup regions, where the central portion is seamlessly joined to the first and second bra cup regions.

8. (canceled)

9. The double-knit flat-knit textile element according to claim 1, wherein the second zone further comprises
strap portions.

10. (canceled)

11. The double-knit flat-knit textile element according to claim 7, a loop length used in the central portion is shorter than a loop length of adjacent regions and/or portions in the second zone, such that the central portion is more rigid than the adjacent regions and/or portions.

12. (canceled)

13. The double-knit flat-knit textile element according to claim 1, wherein the anchoring band is formed from a front knit, a back knit and a tuck stitch.

14. (canceled)

15. The double-knit flat-knit textile element according to claim 1, wherein the anchoring band has a first and second knit modulus zone, where a loop length of the first zone is different from the second zone.

16. The double-knit flat-knit textile element according to claim 15, wherein the second knit modulus zone further comprises wing portions.

17. (canceled)

18. The double-knit flat-knit textile element according to claim 7, wherein the central portion of the second zone is divided into a first section and a second section, where the first and second sections are adapted to be reversibly engageable with one another.

19-22. (canceled)

23. The double-knit flat-knit textile element according to claim 1, wherein the second zone further comprises a plurality of further regions comprising:
(a) a first and a second wing portion region;
(b) a neckline region;
(c) a cup connecting region;
(d) a first and a second cup periphery region corresponding to the first and second bra cup regions, respectively; and
(e) a first and second strap portion.

24. (canceled)

25. The double-knit flat-knit textile element according to claim 23, wherein the first and the second cup periphery region is a single layer that is created by a transition from a periphery of the first and second bra cup regions, having at least two layers, to the single layer of the first and the second cup periphery region, respectively.

26. (canceled)

27. The double-knit flat-knit textile element according to claim 25, wherein the first and the second cup periphery region is formed using one more types of yarn selected from an elastic covered yarn and/or an uncovered version of the same yarn type.

28. The double-knit flat-knit textile element according to claim 23, wherein the first and second strap portions are each formed by knitting a first strap layer and a second strap layer, where both strap layers are formed by a double jersey structure and are connected together by one or more tuck stitches.

29. (canceled)

30. The double-knit flat-knit textile element according to claim 23, wherein the anchoring band has a first and second knit modulus zones, where the loop length of the first zone is different from the second zone, wherein one or more of the following apply:
(i) the first knit modulus zone is placed under the first and second bra cup regions, while the second knit modulus zone is placed below the wing portion of the flat-knit bra, where the first knit modulus zone has a shorter knit loop length than the second knit modulus zone;
(ii) the first and second knit modulus zones of the anchoring band each further split into three separate modulus sub-zones,
where the zones or loop lengths are formed from one or more covered yarn.

31-33. (canceled)

34. The double-knit flat-knit textile element according to claim 1, wherein the base fabric of the first and second bra cup regions comprises one or more of the following stitch sequences:
(i) the flat-knit bra cup zone is formed at least in part with two distinct single jersey fabric layers that follows the knit sequence of FIG. 24, which requires a front stitch (33) and a rear stitch (34) that form two repeating courses;
(ii) the flat-knit bra cup zone is formed at least in part with two distinct single jersey fabric layers that follows the knit sequence of FIG. 27 using courses (45)(46);
(iii) the flat-knit bra cup zone is formed at least in part with two distinct single jersey fabric layers that follows the knit sequence of FIG. 28 using courses (47)(48)(49)(50);
(iv) the flat-knit bra cup zone is formed at least in part with three distinct single jersey fabric layers that follows the knit sequence of FIG. 57 that follows a stitch sequence, which requires a front stitch, miss stitch (153), miss stitch, front stitch (154), miss stitch, rear stitch (155);
(v) the flat-knit bra cup zone is formed at least in part with three distinct single jersey fabric layers that follows the knit sequence of FIG. 58 with a different stitch sequence (156) (157)(158);
(vi) the flat-knit bra cup zone is formed at least in part with three distinct double jersey fabric layers that follows the knit sequence of FIG. 59, which follows a stitch sequence of front stitch, miss stitch, rear stitch, miss stitch, front stitch, miss stitch, rear stitch, miss stitch (159), miss stitch, front stitch, miss stitch, miss stitch, miss stitch, rear stitch, miss stitch, miss stitch (160), miss stitch, rear stitch, miss stitch, front stitch, miss stitch, rear stitch, miss stitch, front stitch (161);
(vii) the flat-knit bra cup zone is formed at least in part with three distinct double jersey fabric layers that follows the knit sequence of FIG. 60;
(viii) the flat-knit bra cup zone is formed at least in part with two distinct double jersey fabric layers that follows the knit sequence of FIG. 61, which follows a sequence of front stitch, rear stitch (165), rear stitch, miss stitch, front stitch, miss stitch (166) in repeating pattern;
(ix) the flat-knit bra cup zone is formed at least in part with one double jersey and two single jersey fabric layers that follows the knit sequence of FIG. 25, which is formed with a first and second course of front stitch, rear stitch (35)(36), the third course follows a repeating knit sequence of rear stitch, miss stitch, miss stitch, miss stitch, (37); whilst a fourth course comprises of repeating knit sequence of miss stitch, miss stitch, rear stitch, miss stitch (38);
(x) the flat-knit bra cup zone is formed at least in part with one double jersey and two single jersey fabric layers that follows the knit sequence of FIG. 20 (22)(23)(24);
(xi) the flat-knit bra cup zone is formed at least in part with one double jersey and two single jersey fabric layers that follows the knit sequence of FIG. 22 (28)(29)(30);
(xii) the flat-knit bra cup zone is formed at least in part with two double jersey and one single jersey fabric layers that follows the knit sequence of FIG. 21 that uses the repeat stitch sequences of rear stitch, front stitch, miss stitch, miss stitch, rear stitch, miss stitch, rear stitch, miss stitch (25) to form the first course; a miss stitch, miss stitch, rear stitch, front stitch, miss stitch, front stitch, miss stitch, front stitch (26) to form the second course; and a miss stitch, rear stitch, miss stitch, rear stitch, miss stitch, rear stitch, miss stitch, rear stitch (27) to form the third course;
(xiii) the flat-knit bra cup zone is formed at least in part with one double jersey and one single jersey fabric layers that follows the knit sequence of FIG. 23 (31)(32);
(xiv) the flat-knit bra cup zone is formed at least in part with one double jersey and one single jersey fabric layers that follows the knit sequence of FIG. 26.

35. The double-knit flat-knit textile element according to claim 1, wherein the said volume is created as follows;
(a) using the stitch sequence of FIG. 26, which provides two courses in accordance to a stitch sequence of front stitch, rear stitch (39)(40) and another four courses are created by rear stitch, miss stitch, miss stitch, miss stitch, rear stitch, miss stitch, miss stitch, miss stitch (41); and a miss stitch, miss stitch, rear stitch, miss stitch, miss stitch, miss stitch, rear stitch, miss stitch (42); which then repeats itself to form the next two courses (43)(44); and/or
(b) using the stitch sequence of FIG. 28, of the flat-knit bra follows a stitch sequence of front stitch (47), rear stitch (48), rear stitch (49), and another rear stitch (50), which forms four individual courses that splits into two layers of fabric.

36. A bra comprising the double-knit flat-knit textile element according to claim 1.
